(19) United States
(12) Patent Application Publication
(10) Pub. No.: US 2026/0281007 A1
(43) Pub. Date: Sep. 17, 2026

(54) Pod Unit, First Cloud Processing Node, and Methods in a Wireless Communications Network

(71) Applicant: Telefonaktiebolaget LM Ericsson (publ), Stockholm (SE)

(72) Inventors: Eric Parsons, Ottawa (CA); Sara Modarres Razavi, Stockholm (SE); Michael Petras, Ottawa (CA); Carola Faronius, Järfälla (SE)

(21) Appl. No.: 19/168,716

(22) PCT Filed: Apr. 11, 2024
(86) PCT No.: PCT/EP2024/059763

§ 371 Date: Sep. 24, 2025

Related U.S. Application Data
(60) Provisional application No. 63/495,344, filed on Apr. 11, 2023.

(51) Int. Cl. H04L 41/40

(52) U.S. Cl. CPC H04L 41/40

(57) ABSTRACT

A method performed by a pod unit for handling communication between a radio unit and at least one cloud processing node is provided. The pod unit performs (404) baseband processing for wireless signals received by, and/or to be transmitted by, the radio unit. In conjunction with said performed baseband processing, the pod unit communicates (405) one or more messages, to and/or from the at least one cloud processing node. When received from the at least one cloud processing node, the one or more messages are at least Radio Link Control (RLC) processed by the at least one cloud processing node. When transmitted to the at least one cloud processing node, the one or more messages are transmitted to be at least RLC processed by the at least one cloud processing node.

### TECHNICAL FIELD

Embodiments herein relate to a pod unit, a first cloud processing node, and methods therein. In some aspects they relate to handling communication between a radio unit and at least one cloud processing node in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHZ. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

### Cloud RAN

The term Cloud RAN, or also referred to as Virtualized RAN, refers to an implementation of RAN processing functions on generic compute platforms, known as Commercial Off-The-Shelf (COTS) hardware. The RAN functions are typically “containerized”, i.e. virtual functions, and may run on an open-source container orchestration system, e.g., Kubernetes, which takes care of automating software deployment, scaling, and management. Cloud RAN is an open architecture where a cloud compute platform, container orchestration, and server hardware no longer need to be provided by one vendor on a monolithic purpose-built platform. In other words, Cloud RAN is a cloud-native software solution handling computation functionality, i.e. processing such as message processing, in the RAN. Cloud RAN may for example be a viable option for communications service providers to have increased flexibility, faster delivery of services, and greater scalability in networks. FIG. 1 illustrates one example architecture and protocols of a Cloud RAN. In FIG. 1, illustrates a centralized Cloud RAN architecture and protocols, where one or more radio units connect via a router to the Cloud RAN architecture for handling certain processing in the RAN.

Cloud Native as used herein is a term that can describe the patterns of organizations, architectures, and technologies that consistently, reliably and at scale fully take advantage of the possibilities of the cloud to support cloud-oriented business models.

Cloud Native can be described as a combination of best practices that have been seen from large entity companies such as e.g., Netflix, Twitter, Alibaba, Uber, Facebook and alike. Practices include, but are not limited to, continuous deployment, containers and microservices to help achieve the elastic scaling capabilities, speed of introducing new functionality and increased automation needed to cater for an unpredictable competitive landscape. An overall goal with cloud native technology is therefore to be able to adapt computational resources quickly and cost efficiently.

### SUMMARY

Problems with processing communication in RAN were identified as part of developing embodiments herein. In particular, it was identified that many cloud solutions associated with RAN communication require most processing to be performed on the edge, i.e., in the RAN and/or physically on nodes close to a user. Such approaches may impede on flexibility and scalability as the system and/or processing may be limited to capabilities of a physical node.

An object of embodiments herein is to improve flexibility and efficiency of processing communication.

According to a first aspect, a method performed by a pod unit for handling communication between a radio unit and at least one cloud processing node in a wireless communications network is provided. The pod unit is arranged to perform baseband processing for wireless signals sent to, and/or to be transmitted by, the radio unit. The at least one cloud processing node is arranged to at least handle Radio Link Control (RLC) processing of messages communicated between the pod unit and the at least one cloud processing node.

The pod unit performs baseband processing for wireless signals received by, and/or to be transmitted by, the radio unit. In conjunction with said performed baseband processing, the pod unit communicates one or more messages, to and/or from the at least one cloud processing node. When received from the at least one cloud processing node, the one or more messages are at least RLC processed by the at least one cloud processing node. Additionally or alternatively, when transmitted to the at least one cloud processing node, the one or more messages are transmitted to be at least RLC processed by the at least one cloud processing node.

According to a second aspect, a method performed by a first cloud processing node for handling communication between a radio unit and at least one cloud processing node comprising the first cloud processing node in a wireless communications network is provided. A pod unit is arranged to perform baseband processing for wireless signals sent to, and/or to be transmitted by, the radio unit. The first cloud processing node is arranged to at least handle RLC processing of messages communicated between the pod unit and the at least one cloud processing node. The first cloud processing node performs at least RLC processing of at least part of one or more messages transmitted to and/or received from the pod unit. In conjunction with performing at least RLC processing of at least part of the one or more messages, the first cloud processing node communicates said one or more messages, with the pod unit. When the one or more messages are transmitted to the pod unit, the one or more messages are transmitted to be baseband processed by the pod unit. Additionally, or alternatively, when the one or more messages are received from the pod unit, the one or more messages are baseband processed by the pod unit, and triggering first cloud processing node to perform the RLC processing of at least part of the one or more messages.

According to a third aspect, a pod unit configured to handle communication between a radio unit and at least one cloud processing node in a wireless communications network is provided. The pod unit is arranged to perform baseband processing for wireless signals sent to, and/or to be transmitted by, the radio unit. The at least one cloud processing node is arranged to at least handle RLC processing, of messages communicated between the pod unit and the at least one cloud processing node. The pod unit is configured to:
perform baseband processing for wireless signals received by, and/or to be transmitted by, the radio unit,
in conjunction with said performed baseband processing, communicate one or more messages, with the at least one cloud processing node, wherein any one or both out of:
   when received from the at least one cloud processing node, the one or more messages are at least RLC processed by the at least one cloud processing node, and
   when transmitted to the at least one cloud processing node, the one or more messages are at least RLC processed by the at least one cloud processing node.

According to a fourth aspect, a first cloud processing node configured to handle communication between a radio unit and at least one cloud processing node comprising the first cloud processing node in a wireless communications network is provided. A pod unit is arranged to perform baseband processing for wireless signals sent to, and/or to be transmitted by, the radio unit. The first cloud processing node is arranged to at least handle RLC processing of messages communicated between the pod unit and the at least one cloud processing node comprising the first cloud processing node. The first cloud processing node being configured to:
perform at least RLC processing of at least part of one or more messages transmitted to and/or received from the pod unit,
in conjunction with performing at least RLC processing of at least part of the one or more messages, communicate said one or more messages, with the pod unit,
wherein said one or more messages are adapted to:
   when transmitted to the pod unit, the one or more messages are arranged to be transmitted to be baseband processed by the pod unit, and/or
   when received from the pod unit, the one or more messages are baseband processed by the pod unit, and wherein the one or more messages are arranged to trigger the first cloud processing node to perform the RLC processing of at least part of the one or more messages.

Since the pod unit performs baseband processing for the wireless signals, and the at least one cloud processing node, in particular the first cloud processing node, performs RLC processing of at least part of the one or more messages, it is possible to split the baseband processing and RLC processing and move the RLC processing to the cloud. This means that the RLC processing can be scaled up and down flexibly in order to achieve the efficiency needed. Furthermore, since the RLC processing is effectively offloaded to the at least one cloud processing node, in particular the first cloud processing node, the pod unit needs less resources than if having to also perform RLC processing. As a consequence, resource management in network locations comprising the pod unit is improved such as on the edge of the wireless communications network.

### BRIEF SUMMARY OF DRAWINGS

Examples of embodiments herein are described in more detail with reference to attached drawings in which:

FIG. 1 illustrates a cloud architecture according to prior art.

FIG. 2 illustrates a schematic block diagram illustrating embodiments of a wireless communications network.

FIG. 3 illustrates an example architecture according to embodiments herein.

FIG. 4 is a flowchart depicting embodiments of a method.

FIG. 5 is a flowchart depicting embodiments of a method.

FIG. 6 is a schematic block diagram illustrating embodiments of a pod unit.

FIG. 7 is a schematic block diagram illustrating embodiments of a first cloud processing node.

FIGS. 8-13 schematically illustrates a communication system in accordance with some embodiments.

### DETAILED DESCRIPTION

As summarized above, part of developing embodiments herein a problem was identified which will further be discussed below.

In the telecommunications sector, many operators and vendors are embracing cloud native technologies. Although they have been adopted among public cloud and Information Technology (IT) entities for some time, there are some different challenges for the telecoms industry. One challenge is that applications must be able to run on different infrastructures as most service providers have bespoke configurations, i.e. configurations specialized for a certain setup that need to be adhered to. The four main areas impacted by its adoption are:
Application design and development,
Technology and infrastructure,
Processes and ways of working, and
Management and orchestration.

These four aspects do not exist in isolation. They all influence each other, and so none of them should be overlooked at any point in time. For example, if applications, infrastructure and orchestration all follow cloud-native design patterns, yet the ways of working and organizational setup and model does not take advantage of the cloud-native setup, the full potential will not be reached.

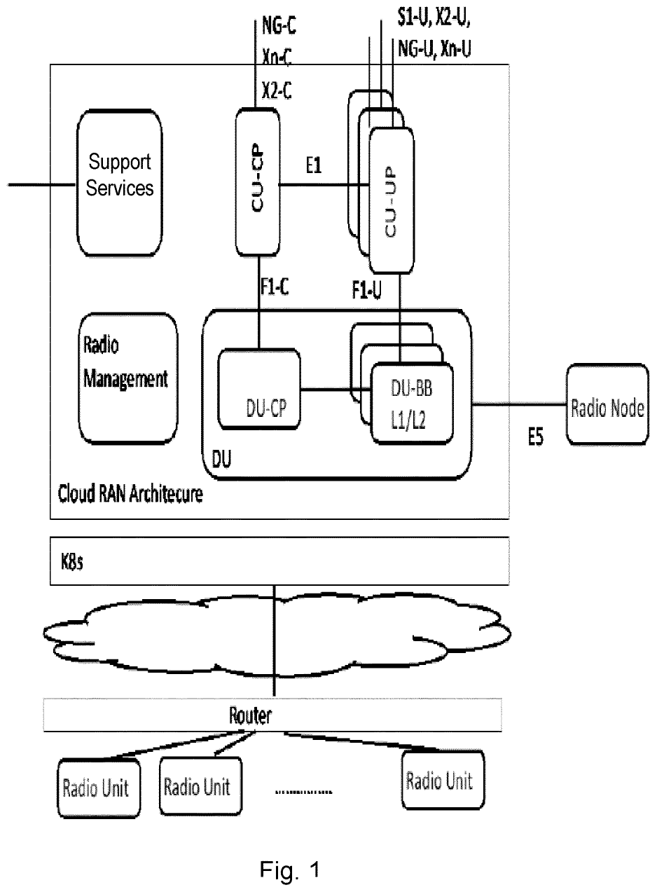

Current Cloud RAN architectures, for example the architecture depicted in FIG. 1, does not include all the potentials of a Cloud Native solution. Many components are still within the edge, meaning the components are physically located at a base station and are communicating within an F1 protocol to central units of the RAN. Such an approach reduces capabilities of a full cloud native potentials in terms of flexibility and scalability, while also reduce the possibilities of energy savings in a large scale deployment.

Embodiments herein may relate to using a small Baseband (BB) pod, or also referred to as a pod unit e.g., on one server, as a separate baseband processing unit, e.g., on each radio site such. The pod unit may not require a complete server and instead, an appliance, or any other suitable network node would suffice for hosting the pod unit. The pod unit may be a virtual function but may also be its own control and/or communication unit. The pod unit is arranged to be stateless or at least partially stateless, meaning that it can be restarted quickly at any time and recover and/or re-establish any non-transitory state signaled from a central entity, e.g., a server. By the assumption of having stateless or at least partially stateless pod unit, a need for having storage for saving states of the pod unit in the case of shut down and restart is eliminated. The solution of embodiments herein may also relate to requiring and/or allowing the units in a current Cloud RAN architecture setup, e.g., certain processing, to move to the cloud and to be run centrally, e.g., by at least one cloud processing node. The units and/or corresponding processing that may be run on the cloud, due to this architecture may for example comprise any one or more out of:
Distributed Unit-Control Plane (DU-CP),
Centralized Unit-Control Plane (CU-CP),
Centralized Unit-User Plane (CU-UP), and
Container as a Service controller (CaaS controller).

Advantages herein may relate to many different aspects which appears when having states that does not need to be stored and managed by the pod unit. Additionally or alternatively, advantages herein may further relate to enable offloading processing to at least one cloud processing node, e.g., which have previously needed to be part of a gNB or other device close to antenna units. Offloading processing to the at least one cloud processing node improves flexibility and efficiency of processing in the RAN, e.g., as it may be more efficient to scale resources in a cloud environment, e.g., based on what resources are needed for processing. Further advantages will be explained in relation to embodiments and examples below.

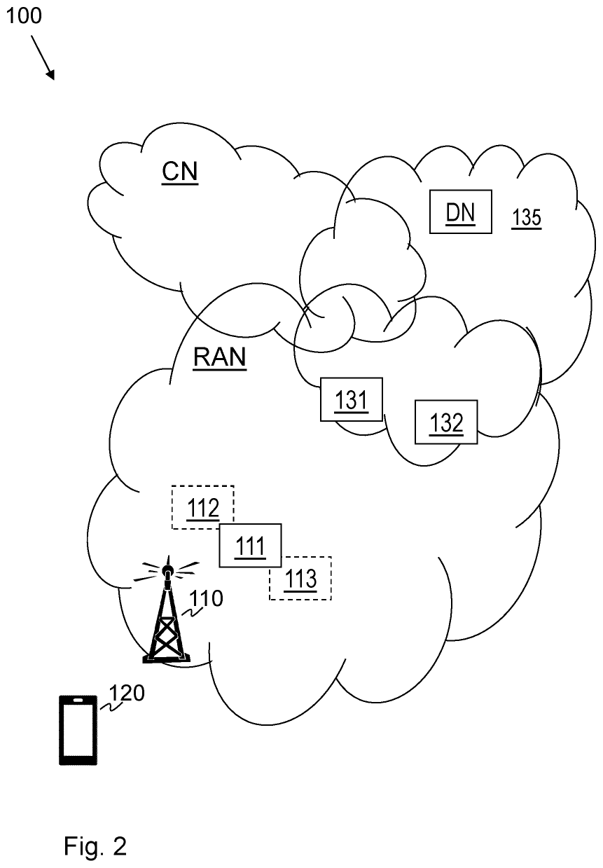

FIG. 2 is a schematic overview depicting a wireless communications network 100, such as e.g. a telecommunications network, wherein embodiments herein may be implemented. The communications network 100 comprises one or more RANs and one or more CNs. The communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Radio units, e.g., a radio unit 110 may operate in the wireless communications network 100. The radio unit 110 may e.g. provides a number of cells, and may use these cells for communicating with other network entities, e.g., the UE 120. The radio unit 110 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, an antenna unit, a Wireless Local Area Network (WLAN) access point, an Access Point Station (AP STA), an access controller, a UE acting as an access point or a peer in a Device to Device (D2D) communication, or any other network unit capable of communicating with a UE and/or a pod unit 111, as discussed below.

Cloud processing nodes, e.g., at least one cloud processing node 131, 132 may operate in the wireless communications network 100. The at least one cloud processing node 131, 132 may comprise a first cloud processing node 131 and/or a second processing node 132. While a first and second processing node 131, 132 is exemplified herein, the at least one cloud processing node 131, 132 may comprise any suitable number of cloud processing nodes, e.g., three or more cloud processing nodes.

The at least one cloud processing node 131, 132, e.g., the first cloud processing node 131 and/or the second processing node 132, may be arranged in any suitable network node and/or cloud environment, e.g., in a COTS hardware. The at least one cloud processing node 131, 132, e.g., the first cloud processing node 131 and/or the second processing node 132, may be configured to handle processing of communication and/or messages from and/or to the radio unit 110. The at least one cloud processing node 131, 132, e.g., the first cloud processing node 131 and/or the second processing node 132, may be configured to perform processing otherwise part of a logical gNB, such as a gNB-DU.

The at least one cloud processing node 131, 132, e.g., the first cloud processing node 131 and/or the second processing node 132, may be part of a cloud environment and/or part of a hyper scalar.

The at least one cloud processing node 131, 132, e.g., the first cloud processing node 131 and/or the second processing node 132, may be distributed logically and/or physically in one or more different servers, network nodes, cloud environments, e.g., as part of a public, private, or hybrid cloud environment.

The at least one cloud processing node 131, 132, e.g., the first cloud processing node 131 and/or the second processing node 132, may be, e.g., in one or more out of the at least one cloud processing node 131, 132, configured to handle Radio Link Control (RLC) processing of communication in the wireless communications network, e.g., of messages communicated with the radio unit 111, e.g., via the pod unit 111 as discussed below.

The at least one cloud processing node 131, 132, e.g., the first cloud processing node 131 and/or the second processing node 132, may further be, e.g., in one or more out of the at least one cloud processing node 131, 132, configured to handle any other higher layer protocol processing of messages communicated with the radio unit 111, e.g., via the pod unit 111 as discussed below, such as any one or more out of:
DU-CP processing,
CU-CP processing,
CU-UP processing, and
CaaS controller processing.

In other words it is possible to “offload” higher layer processing to a cloud environment, by use of the at least one cloud processing node 131, 132.

Pods also referred to as pod units or Baseband (BB) pods, e.g., the pod unit 111, may operate in the wireless communications network 100. While the pod unit 111 will be referred to as a single pod or pod unit, the pod unit 111 and/or embodiments herein may also be or comprise any suitable number of pod units. The pod unit 111 may be a virtual function, e.g., a container such as a virtual container in a software system. The pod unit 111 may be part of any suitable network entity, e.g., part of the radio unit 110 or communicatively connected to the radio unit 110. Alternatively, the pod unit 111 may form its own physical network entity, e.g., as a control unit, radio unit, appliance, server, network node, or any other suitable unit. The pod unit 111 may be a BB pod, i.e. arranged to perform baseband processing of wireless signals to be transmitted by, and/or received by the radio unit 110. In other words, the pod unit 1111 may be arranged to perform baseband processing for wireless signals sent to, and/or to be transmitted by, the radio unit 100. The baseband processing performed by the pod unit 111 may comprise layer 1 and/or MAC processing, Physical Layer (PHY) processing, beamforming and/or other suitable beam management processing. The pod unit 111 may be a Kubernetes pod. The pod unit 111 may also be referred to as a pod or a BB pod.

UEs, such as the UE 120, operate in the wireless communications network 100. The UE 120 may e.g. be an NR device, a mobile station, a wireless terminal, an IoT device, an IoS device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, a Vehicle-to-Network (V2N) device, a Wi-Fi device, an LTE device, a non-access point (non-AP) STA, a STA, that communicates via a base station such as e.g. the network node 110, and one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell. Embodiments herein may be directed towards processing and/or handling communication towards and/or from the UE 120, e.g., via the radio unit 110 and the at least one cloud processing node 131, 132.

In some embodiments, network nodes such as a network node 112, may operate in the wireless communications network 100. The network node 112 be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, an antenna unit, a Wireless Local Area Network (WLAN) access point, an Access Point Station (AP STA), an access controller, a UE acting as an access point or a peer in a Device to Device (D2D) communication, or any other network unit capable of communicating with a UE and/or with the pod unit 111. The network node 112 may be a server e.g., in the RAN. The network node 112 may have communications capabilities, e.g., wired and/or wireless, e.g., such that the appliance may communicate with any one or more out of the pod unit 111, the radio unit 110, and/or the at least one cloud processing node 131, 132

In some embodiments, the network node 112 may comprise and/or instantiate the pod unit 111.

In some embodiments, appliances such as an appliance 113, may operate in the wireless communications network 100. The appliance 113 may be any suitable network entity capable of comprising/instantiating the pod unit 111. The appliance 113 may have communications capabilities, e.g., wired and/or wireless, e.g., such that the appliance may communicate with any one or more out of the pod unit 111, the radio unit 110, and/or the at least one cloud processing node 131, 132. The appliance 113 may be a Television (TV) box, or any other smart device. In some embodiments, the appliance 113 may comprise/instantiate the pod unit 111.

Methods herein may in one aspect be performed by the pod unit 111. Alternatively, the methods may be performed by the entity which comprises and/or instantiates the pod unit 111. E.g., the appliance 113 or the network node 112, or the radio unit 110. In another aspect methods herein may be performed by the first cloud processing node 131.

A Distributed Node (DN) and functionality, e.g. comprised in a cloud 135 as shown in FIG. 2, may be used for performing or partly performing the methods of embodiments herein, e.g., the at least one processing node 131, 132 may, e.g., besides from logically being part of the RAN, be arranged in the DN and/or cloud 135, or in any other suitable cloud environment and/or COTS hardware. The cloud 135 may comprise a cloud network infrastructure. A cloud network infrastructure may e.g. be a collection of hardware and software elements such as computing power, networking, storage, and virtualization resources needed to enable cloud computing in a wireless communications network such as e.g. the wireless communications network 100. The cloud 135 may be a public, private, or hybrid cloud environment.

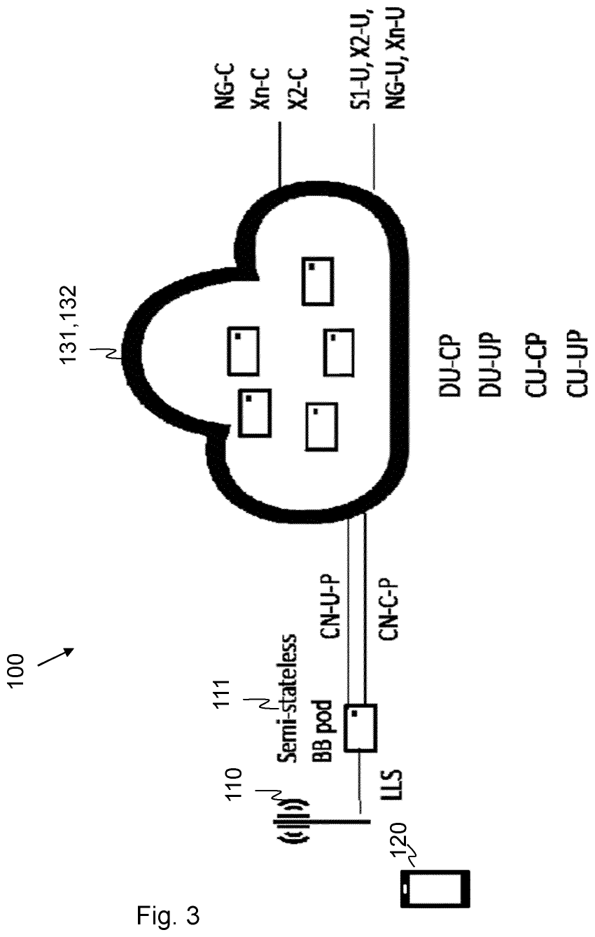

FIG. 3 is an alternative schematic overview depicting the wireless communications network 100. The radio unit 110 may communicate with the pod unit 111, e.g., using a Lower Layer Split (LLS). The radio unit 110 may receive, and/or transmit wireless signals, e.g., to the UE 120, and the wireless signals may be processed by the pod unit 111. The pod unit 111 may perform lower layer processing of the wireless signals, e.g., any one or more out of: MAC processing, PHY processing, layer 1 processing, part of layer 2 processing excluding RLC processing, beamforming, Layer 1 and/or Layer 2 scheduling.

The pod unit 111 may communicate with the at least one cloud processing node 131, 132, e.g., in uplink and/or downlink with respect to communication to and/or from the UE 120. The pod unit 111 may communicate with the at least one cloud processing node 131, 132, e.g., in uplink and/or downlink, using protocols and/or interfaces designed for the embodiments herein, e.g., for communication between the pod unit 111 and the at least on cloud processing node 131, 132. The protocols and/or interfaces used for communication between the pod unit 111 and the at least on cloud processing node 131, 132 may be a Cloud Native User Protocol (CN-U-P), and Cloud Native Control Protocol (CN-C-P). CN-U-P may be used for user data for communication between the pod unit 111 and the at least on cloud processing node 131, 132. CN-C-P may be used for control data for communication between the pod unit 111 and the at least on cloud processing node 131, 132.

The at least one cloud processing node 131, 132 may perform any suitable processing of user and/or control data in the wireless communications network 100, e.g., that is not performed by the pod unit 111. The at least one cloud processing node 131, 132 may perform at least RLC processing of messages, e.g., user data and/or control data, transmitted from/to the pod unit 111.

The at least one cloud processing node 131, 132 may perform processing of a gNB, e.g., any one or more out of:
DU-CP processing,
CU-CP processing,
CU-UP processing, and
CaaS controller processing.

To exemplify how gNB processing may be part of the at least one cloud processing node 131, 132, the following example may be considered. A gNB-DU, defined by 3GPP, e.g., 3GPP TS 38.401, may be a logical node hosting RLC, MAC and PHY layers of a gNB or an en-gNB, and its operation is partly controlled by a gNB-CU. en-gNB as used herein may represent a gNB that can connect with Evolved Packet Core (EPC) and eNB. A gNB-DU may support one or multiple cells. One cell may be supported by only one gNB-DU. The gNB-DU may terminate an F1 interface connected with a gNB-CU. For a Dual Connectivity (DC) operation, a Master gNB-DU designates a gNB-DU of an en-gNB or a gNB acting as a master node, and a Secondary gNB-DU the gNB-DU of an en-gNB or a gNB acting as a secondary node. In embodiments herein, instead of having the processing of any one or more out of the above-mentioned gNBs, gNB-DU, SgNB-DU, MgNB-DU, en-gNB, the respective processing can be performed by any one or more cloud processing nodes in the at least one cloud processing node 131, 132. This further allows gNB processing such as gNB-DU and/or gNB-CU processing to have more flexibility, and may enable to no longer have a CU and DU separation e.g., into different physical entities. This may also allow gNB-DU interfaces to be supported by a multiplicity of physically distanced compute elements, thus forming a geographically distributed gNB-DU instance.

Embodiments herein may reduce a Cloud RAN hardware footprint, e.g., at a base station, network nodes, etc. This is since embodiments herein may relate to keeping only a minimal or at least lightweight stateless or at least partly stateless Baseband (BB) pod unit 111, and moving the remaining of the architecture into the Cloud, e.g., the at least one cloud processing node 131, 132, and virtualizing them. This may mean that a distinction between some units and/or processing, e.g., DU, CU, and the F1 protocol can all be removed, e.g., as they can be performed in any suitable manner concurrently in the at least one cloud processing node 131, 132.

Embodiments herein may relate to an RLC-MAC split, e.g., where RLC processing is handled by the at least one cloud processing node 131, 132, and MAC processing is handled by the pod unit 111. The RLC-MAC split may enable states and state parameters, e.g., relating to UEs, e.g., the UE 120, and/or to cells/sectors to be recoverable from the at least one cloud processing node 131, 132, making the pod unit 111 as stateless as possible. Embodiments herein are applicable to both LTE and/or NR, while it is also applicable for next generation communications, such as for 6G.

In some embodiments, the baseband would remain on a same name space, e.g., as for legacy baseband processing in LTE and/or NR.

In embodiments herein, there would be no gNB instantiation at the pod unit 111, but instead, a gNB would be represented by entities in the cloud domain, e.g., the at least one cloud processing node 131, 132, which may be deployed in a different location than the pod unit 111, e.g., in any suitable cloud environment. This may mean that application management functions would interface with services in the cloud domain, e.g., the at least one cloud processing node 131, 132, where the gNB entity resides, rather than in the pod unit 111, thus improving flexibility and/or efficiency of the application management functions.

For example, one or more out of the following advantages may apply to embodiments herein
Operational efficiency and shorter time to market for new services, e.g., as software and/or processing, e.g., in the at least one cloud processing node 131, 132, may both be more decoupled from underlaying hardware and decomposed into smaller components, leveraging software agility that emerges from cloud deployments,
faster and more automated upgrades, also referred to as Continuous Integration (CI) and Continuous Deployment (CD), e.g., this is since cloud entities such as the at least one cloud processing node 131, 132, is more easily accessible and reconfigurable than physical entities e.g., close to the antenna units,
Reduction on physical and logical protocols between different units, e.g., this is since multiple units and/or processing thereof is moved to the cloud, which means that the protocol in between them need not to be physical, e.g., the different units and/or processing thereof may all end up in one or multiple cloud processing nodes, so lot of reduction may therefore be a logical consequence,
Improve granularity and increase speed of software upgrades and releases, e.g., this is since cloud entities such as the at least one cloud processing node 131, 132, is more easily accessible and reconfigurable than physical entities,
Adapt software architecture to make much better use of cloud data center resources, due to having the processing in the at least one cloud processing node 131, 132, the processing may adapt to the parallel and/or scalable nature of cloud computing, making the processing possible to run in a more parallel and scalable setting, i.e. performance may be increased for the processing,
Simplification of cell-site management by moving to an appliance model with very little or no persistent configuration state to manage, simplified Life Cycle Management, LCM, simplified maintenance, e.g., this is since a less need of having very many different units in the Cloud ran architecture. A differentiation between a virtual DU (vDU) and a virtual CU (vCU) is no longer needed, and therefore a lot of LCM processes may be simplified accordingly,
Reduced physical space needed for base station deployments, e.g., comprising the pod unit 111 and/or the radio unit 110, e.g., as the at least one cloud processing node 131, 132, may perform processing otherwise needed to be part of the base stations deployments,
Reduced energy consumption in relation to deployment, transportation, and energy consumption at the site, e.g., comprising the pod 111, this is since the energy/power consumption for maintaining the hardware at the site, transportation and deployment is removed due to moving units and/or processing thereof to the cloud,
A large memory reduction requirement at the site, e.g., at a base station comprising the pod unit 111 and/or the radio unit 110, this is since memory footprint of states, e.g., state parameters, may be moved to be maintained by the at least one cloud processing node 131, 132.

Moreover, an application support services footprint in an BB server/appliance may be either eliminated or significantly minimized and handled centrally, e.g., this is since the application support services may be moved to the cloud, e.g., the at least one cloud processing node 131, 132. The new architecture of embodiments herein may change a current Cloud RAN architecture setup, which may mean that there is no reason to have a distinction between DU and CU, and the tasks of DU will be also controlled by a central unit, e.g., the same cloud processing node of the at least one cloud processing node 131, 132 may perform both processing tasks of DU and CU. Another significant change may be that the F1 interface may be completely removed, e.g., due to not having DU and CU distinctions.

A number of embodiments will now be described, some of which may be seen as alternatives, while some may be used in combination.

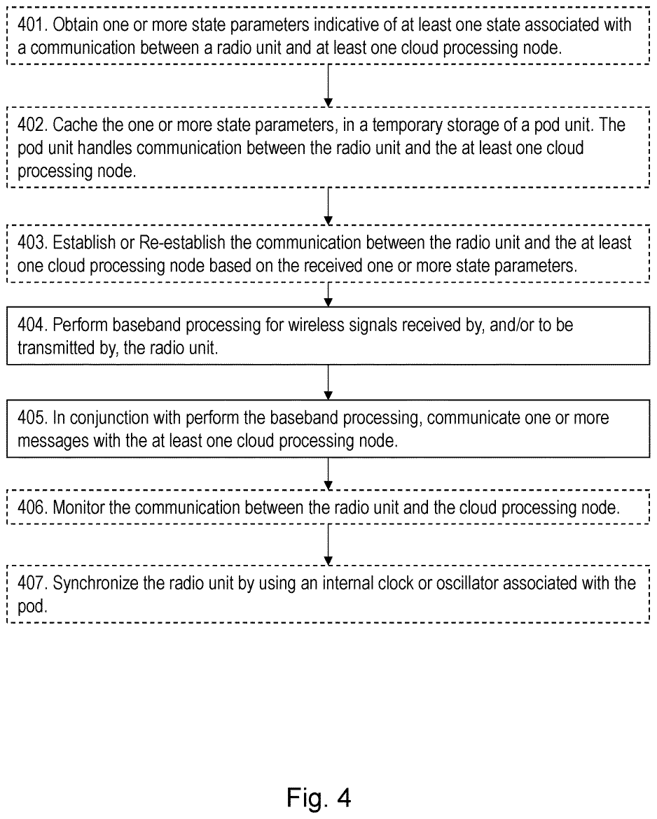

FIG. 4 shows exemplary embodiments of a method performed by the pod unit 111 for handling communication between the radio unit 110 and at the least one cloud processing node 131, 132, in the wireless communications network 100. The pod unit 111 may be part of the network node 112, e.g., a server or a base station, or the radio unit 110, or the appliance 113. The pod unit 111 is arranged to perform baseband processing for wireless signals sent to, and/or to be transmitted by, the radio unit 110. Baseband processing may e.g., comprise layer 1 and/or MAC processing. In some embodiments, the baseband processing may comprise stateless parts of RLC processing, e.g., RLC segmentation. The at least one cloud processing node 131, 132 is arranged to at least handle RLC processing of messages communicated between the pod unit 111 and the at least one cloud processing node 131, 132. In some embodiments, stateless parts of RLC processing, e.g., RLC segmentation, is not performed by the at least one cloud processing node 131, 132.

The method comprises the following actions, which actions may be taken in any suitable order. Optional actions are referred to as dashed boxes in FIG. 4.

### Action 401

The pod unit 111 may obtain, e.g., receive from the at least one cloud processing node 131, 132, one or more state parameters indicative of at least one state associated with the communication between the radio unit 110 and the at least one cloud processing node 131, 132.

The one or more state parameters may indicate any suitable state, e.g., that may be part of RLC, or that may be maintained by the at least one cloud processing node 131, 132 instead of the pod unit 111.

The one or more state parameters may be parameters that may keep track of any suitable state regarding the communication between the radio unit 110 and the at least one cloud processing node 131, 132, e.g., RLC states.

In some embodiments, the one or more state parameters comprises or is indicative of any one or more out of:
states, parameters, and/or configurations of a User Equipment, UE, 120, associated with the communication between the radio unit 110 and the at least one cloud processing node 131, 132, e.g., a UE context of the UE 120, an identifier of the UE 120,
states, parameters, and/or configurations of a cell associated with the communication between the radio unit 110 and the at least one cloud processing node 131, 132, e.g., such as a frequency band of the cell, Cell Identifier such as a Physical Cell Identifier, PCI, a type of the cell, identifiers of neighbour cells and/or numbers of neighbour cells,
states, parameters, and/or configurations of a sector associated with the communication between the radio unit 110 and the at least one cloud processing node 131, 132, e.g., a beam configuration, a beam ID, one or more antenna configurations, indication of reference signals in uplink and/or downlink,

one or more counters and/or constants associated with the communication between the radio unit 110 and the at least one cloud processing node 131, 132, e.g., Radio Resource Control (RRC), counters and/or constants defining a target number of attempts for one or more events in the communication between the radio unit 110 and the at least one cloud processing node 131, 132,

one or more events associated with the communication between the radio unit 110 and the at least one cloud processing node 131, 132, e.g., handover events, security control events, periodic and/or triggered measurements of the communication between the radio unit 110 and the at least one cloud processing node 131, 132.

In some embodiments, obtaining the one or more state parameters comprises receiving the one or more state parameters from the at least one cloud processing node 131, 132, e.g., the first cloud processing node 131, and is performed in response to a restart of the pod unit 111, e.g., due to a crash of the pod unit 111.

### Action 402

In some embodiments, the pod unit 111 may cache the one or more state parameters, in a temporary storage of the pod unit 111. Cache or caching as used herein may mean to store parameters locally even though they are maintained and/or stored permanently at a remote location. The one or more state parameters may be lost when the pod unit 111 is restarted, e.g., after a crash. In other words, the pod unit 111 does not need to maintain any latest version of a state, making the pod unit 111 nearly stateless, thereby making the pod unit 111 a lightweight device which can quickly be restarted and which consumes a low amount of power and needs a low capacity of memory.

### Action 403

The pod unit 111 may establish or re-establish the communication between the radio unit 110 and the at least one cloud processing node 131, 132, e.g., based on the received one or more state parameters. Re-establish the communication between the radio unit 110 and the at least one cloud processing node 131, 132, may in some embodiments comprised recovering the communication between the radio unit 110 and the at least one cloud processing node 131, 132.

Recovery as used herein may mean a re-establishment of the communication between the radio unit 110 and the at least one cloud processing node 131, 132, and/or a re-establishment or re-caching of the one or more state parameters.

The establishment or re-establishment may be performed in response to a start or restart of the pod unit 111, e.g., due to a crash of the pod unit 111.

The pod unit 111 may, as part of the establishment or re-establishment, e.g., as in action 401 receive the one or more state parameters from the at least one cloud processing node 131, 132, which may be needed to establish or re-establish, e.g., recover, the communication between the radio unit 110 and the at least one cloud processing node 131, 132, e.g., a UE context, configurations, identifiers, etc. Since this can be performed very quickly, due to not having a lot of states or no states in the pod 111, the UEs may not trigger a Radio Link Failure (RLF).

Establishing or re-establishing, e.g., recovering, the communication between the radio unit 110 and the at least one cloud processing node 131, 132, e.g., based on the received one or more state parameters, may not need to involve caching of the one or more state parameters, e.g., as in action 402. In other words, the establishing or re-establishing, e.g., recovering, of the communication between the radio unit 110 and the at least one cloud processing node 131, 132, may be performed directly from receiving the one or more state parameters comprised in the at least one cloud processing node 131, 132, or a storage/memory of the at least one cloud processing node 131, 132.

### Action 404

The pod unit 111 performs baseband processing, e.g., in uplink and/or downlink to/from the UE 120, for wireless signals received by, and/or to be transmitted by, the radio unit 110, e.g., layer 1 and/or MAC processing, e.g., based on the one or more state parameters.

In other words, the pod unit 111 may perform any suitable baseband processing and/or any suitable lower layer protocol, e.g., below the RLC layer.

The baseband processing may be performed based on any one or more states indicated by the cached one or more state parameters, e.g., cell identifiers, UE identifiers, configurations, e.g., beamforming configurations, cell configurations, communication configurations, etc.

The baseband processing performed by the pod unit 111 may comprise performing stateless RLC processing, e.g., a subpart of RLC processing not performed by the at least one cloud processing node 131, 132. Performing the stateless RLC processing may comprise performing RLC segmentation of PDUs, e.g., by inspection and/or addition of headers which are completely stateless. This may only require inspection of PDU/RLC headers, thus requiring no state in the pod 111. RLC segmentation of PDUs may be performed when data is too large to send, and where the data is needed to be split into two or more RLC segments. Performing RLC segmentation may comprise removing an RLC header and adding one or more RLC segmentation headers for one or more RLC segmented messages e.g., to be sent to the at least one cloud processing node 131, 132.

### Action 405

The pod unit 111, in conjunction with said performed baseband processing, e.g., as in action 404, communicates one or more messages, to and/or from the at least one cloud processing node 131, 132, e.g., based on the one or more state parameters, wherein said one or more messages is:
when received from the at least one cloud processing node 131, 132, the one or more messages are at least RLC processed by the at least one cloud processing node 131, 132, and/or
when transmitted to the at least one cloud processing node 131, 132, the one or more messages are transmitted to be at least RLC processed by the at least one cloud processing node 131, 132.

The one or more messages may be one or more uplink and/or downlink messages, e.g., with respect to the UE 120.

In some embodiments, wherein when the one or more messages are transmitted in uplink, the one or more messages triggers the at least one cloud processing node 131, 132 to at least perform RLC processing of at least part of the one or more messages.

The communication of the one or more messages may be performed based on any one or more states indicated by the cached one or more state parameters, e.g., cell identifiers, UE identifiers, UE contexts, configurations, e.g., beamforming configurations, cell configurations, communication configurations, etc.

In embodiments herein, the term “in conjunction with said performed baseband processing”, may mean before and/or after, and/or concurrently. I.e. Actions 404-405 may be performed in any order and/or concurrently.

### Action 406

In some embodiments, the pod unit 111 may monitor the communication between the radio unit 110 and the at least one cloud processing node 131, 132, e.g., based on the one or more state parameters. Monitoring the communication between the radio unit 110 and the at least one cloud processing node 131, 132, may comprise obtaining one or more observations associated with the communication between the radio unit 110 and the at least one cloud processing node 131, 132, e.g., any one or more out of assistance data, acknowledgements, and/or measurements. The observations may be part of continuous monitoring of the communication such as monitoring of communicated signals and/or measurements of the quality and/or characteristics of the communication and/or said monitored signals. The one or more observations may be measured on the communication between the radio unit 110 and the at least one cloud processing node 131, 132 and/or received by any suitable network entity. The one or more observations may indicate a need for, and/or may trigger any one or more out of:
offloading processing from the pod unit 111 to the at least one cloud processing node 131, 132,
alerting the radio unit 110 and/or a UE 120 of the radio unit 110.

While some examples are given above, the monitoring of the communication between the radio unit 110 and the at least one cloud processing node 131, 132, may trigger any suitable action, e.g., of the pod unit 111 and/or of the at least one cloud processing node 131, 132. When the monitoring of the communication between the radio unit 110 and the at least one cloud processing node 131, 132, detects a condition and/or anomaly, the at least one cloud processing node 131, 132, may be signaled to perform any suitable action.

The monitoring of the communication between the radio unit 110 and the at least one cloud processing node 131, 132, may be used to monitor a state of the communication between the radio unit 110 and the at least one cloud processing node 131, 132, and which is signaled to the at least one cloud processing node 131, 132.

The monitoring of the communication between the radio unit 110 and the at least one cloud processing node 131, 132, may be performed periodically or in response to any suitable event. To reduce the signalling overhead of the monitoring, the frequency may be set to be flexible, or based on a trained machine learning and/or artificial intelligence which is trained to perform the signalling relating to the monitoring at most suitable periods in time, e.g., based on an impact on the communication between the radio unit 110 and the at least one cloud processing node 131, 132, and/or to minimize requirements or resources used by the pod unit 111.

### Action 407

In some embodiments, the pod unit 111 may synchronize the radio unit 110. Synchronizing the radio unit 110 comprises using an internal clock or oscillator associated with the pod unit 111.

Synchronizing the radio unit 110 may mean to synchronize a clock or oscillator of the radio unit 110. In some embodiments, the internal clock or oscillator associated with the pod unit 111 may be an accurate internal clock or oscillator of the appliance 113. This allows a simple and efficient synchronization of the radio unit 110.

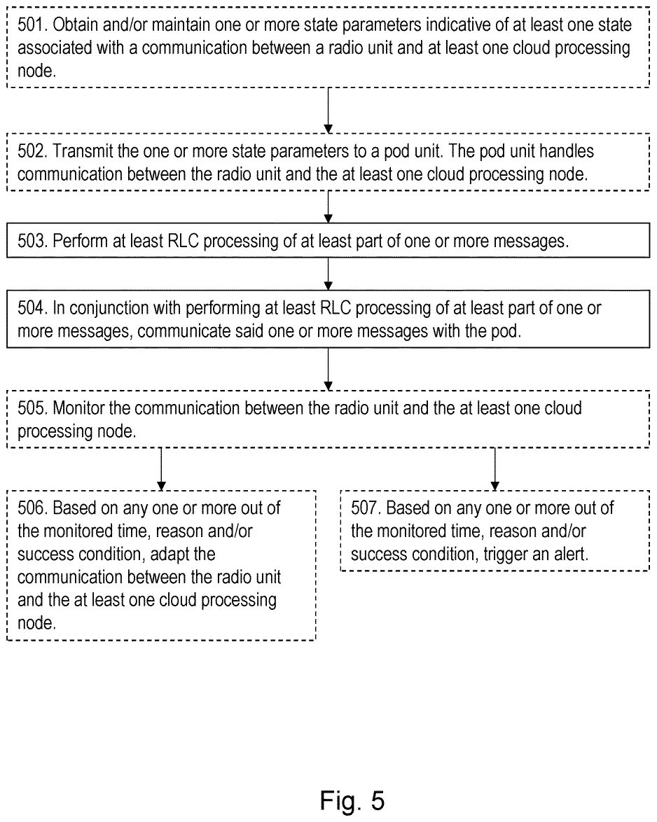

FIG. 5 shows exemplary embodiments of a method performed by the first cloud processing node 131, e.g., for handling communication between the radio unit 110 and the at least one cloud processing node 131, 132 comprising the first cloud processing node 131, in the wireless communications network 100. The pod unit 111 may be arranged to perform baseband processing for wireless signals sent to, and/or to be transmitted by, the radio unit 110. The baseband processing of the pod 111 may comprise layer 1 and/or MAC processing. In some embodiments, the baseband processing may comprise stateless parts of RLC processing, e.g., RLC segmentation. The pod unit 111 may be part of the network node 112, e.g., a server or a base station, or the radio unit 110, or the appliance 113. The first cloud processing node 131 is arranged to at least handle RLC processing of messages communicated between the pod unit 111 and the at least one cloud processing node 131, 132. In some embodiments, stateless parts of RLC processing, e.g., RLC segmentation, is not performed by the at least one cloud processing node 131, 132.

The method comprises the following actions, which actions may be taken in any suitable order. Optional actions are referred to as dashed boxes in FIG. 5.

### Action 501

The first cloud processing node 131 may obtain and/or maintain one or more state parameters indicative of at least one state associated with the communication between the radio unit 110 and the at least one cloud processing node 131, 132, e.g., wherein the one or more state parameters are stored and/or maintained in a non-volatile memory or storage associated with the at least one cloud processing node 131, 132.

In other words, the at least one cloud processing node 131, 132 may be responsible for the one or more state parameters, and when/if they are needed by an external entity such as the pod unit 111, e.g., for handling the communication between the radio unit 110 and the at least one cloud processing node 131, 132, the one or more state parameters may need to be transmitted from the at least one cloud processing node 131, 132, to the pod unit 111.

The one or more state parameters may, in some embodiments, be obtained and/or maintained in collaboration with one or more other node of the at least one cloud processing node 131, 132.

The one or more state parameters may indicate any suitable state, e.g., that may be part of RLC, or that may be maintained by the at least one cloud processing node 131, 132 instead of the pod unit 111.

The one or more state parameters may be parameters that may keep track of any suitable state regarding the communication between the radio unit 110 and the at least one cloud processing node 131, 132, e.g., RLC states.

The one or more state parameters comprises or is indicative of any one or more out of:
states, parameters, and/or configurations of the UE 120, associated with the communication between the radio unit 110 and the at least one cloud processing node 131, 132, e.g., a UE context of the UE 120, e.g., an identity of the UE 120
states, parameters, and/or configurations of a cell associated with the communication between the radio unit 110 and the at least one cloud processing node 131, 132, e.g., such as a frequency band of the cell, Cell Identifier such as a Physical Cell Identifier, PCI, a type of the cell, identifiers of neighbour cells and/or numbers of neighbour cells,
states, parameters, and/or configurations of a sector associated with the communication between the radio unit 110 and the at least one cloud processing node 131, 132, e.g., a beam configuration, a beam ID, one or more antenna configurations, indication of reference signals in uplink and/or downlink,

one or more counters and/or constants associated with the communication between the radio unit 110 and the at least one cloud processing node 131, 132, e.g., Radio Resource Control (RRC) counters and/or constants defining a target number of attempts for one or more events in the communication between the radio unit 110 and the at least one cloud processing node 131, 132,

one or more events associated with the communication between the radio unit 110 and the at least one cloud processing node 131, 132, e.g., handover events, security control events, periodic and/or triggered measurements of the communication between the radio unit 110 and the at least one cloud processing node 131, 132.

### Action 502

The first cloud processing node 131 may transmit the one or more state parameters to the pod unit 111, e.g., for being temporarily cached and/or used by the pod unit 111, e.g., in response to a restart and/or crash of the pod unit 111.

The one or more state parameters may be transmitted to the pod unit, e.g., by request of the pod unit 111 and/or periodically and/or based on any suitable event where state parameters may be needed by the pod unit 111.

The one or more state parameters may be transmitted to the pod unit 111, e.g., upon restart of the pod unit 111, e.g., due to a crash of the pod unit 111.

### Action 503

The first cloud processing node 131 performs at least RLC processing of at least part of one or more messages, e.g., based on the one or more state parameters. The RLC processing may be triggered to be performed based on receiving the one or more messages, e.g., from the pod unit 111.

In some embodiments, performing the at least RLC processing of at least part of the one or more messages comprises any one or more out of:
handling an RLC window of the communication between the radio unit 110 and the at least one cloud processing node 131, 132,
handling RLC buffer insertion associated with the communication between the radio unit 110 and the at least one cloud processing node 131, 132,
handing processing relating to any one or more out of:
   DU-CP processing,
   CU-CP processing,
   CU-UP processing, and
   CaaS controller processing.

The RLC processing or other processing performed by the at least one cloud processing node 131, 132 may further relate to function management of radios, diagnostics, handling database services, initialization of radio units, such as the radio unit 110, to be ready for use in embodiments herein, application support services or other services, service discovery in particular for RAN, etc. In other words, the first cloud processing node 131 may perform any suitable processing as part of the at least RLC processing of at least part of the one or more messages. While embodiments herein mostly emphasize on offloading RLC processing to the at least one cloud processing node 131, 132 such as the first cloud processing node 131, other processing may also apply to embodiments herein.

The processing above may be associated with the communication between the radio unit 110 and the at least one cloud processing node 131, 132, e.g., in coordination with a second cloud processing node 132 of the at least one cloud processing node 131, 132.

In other words, the first cloud processing node 131, may, e.g., in coordination and/or cooperation with one or more other nodes out of the at least one cloud processing node 131, 132, perform any suitable higher level protocol, e.g., RLC and above, e.g., for the communication between the radio unit 110 and the at least one cloud processing node 131, 132.

The first cloud processing node 131 may in some embodiments not perform one or more stateless RLC processing operations, e.g., RLC segmentation, e.g., as these stateless processing operations may instead be performed by the pod 111, without the pod 111 having to maintain one or more states of the communication between the radio unit 110 and the at least one cloud processing node 131, 132. The at least one cloud processing node 131, 132 may however perform RLC processing operations involving and/or needing states of the communication between the radio unit 110 and the at least one cloud processing node 131, 132, e.g., data transfer and/or indication of successful delivery of upper layer Protocol Data Unit (PDU) services e.g., to RRC and/or Packet Data Convergence Protocol (PDCP).

### Action 504

The first cloud processing node 131, in conjunction with performing at least RLC processing of at least part of one or more messages, e.g., as in action 503, communicates said one or more messages, e.g., one or more uplink and/or downlink messages, with the pod unit 111, e.g., based on the one or more state parameters.

The one or more messages may:
when transmitted in downlink, be transmitted to be baseband processed by the pod unit 111, and/or
when received in uplink, be received as being baseband processed by the pod unit 111.

When the one or more messages are received in uplink, the one or more messages may trigger the first cloud processing node 131 to perform the RLC processing of at least part of the one or more messages, e.g., as in action 503.

In embodiments herein, the term “in conjunction with performing at least RLC processing of at least part of the one or more messages”, may mean before and/or after, and/or concurrently. I.e. Actions 503-504 may be performed in any order and/or concurrently.

### Action 505

The first cloud processing node 131 may monitor the communication between the radio unit 110 and the at least one cloud processing node 131, 132, e.g., based on the one or more state parameters. Monitoring the communication between the radio unit 110 and the at least one cloud processing node 131, 132, may comprise monitoring:

a time since a last establishment or re-establishment, e.g., recovery, of the pod unit 111, e.g., a time since transmitting the one or more state parameters to the pod unit 111, e.g., as in action 502,

a reason of the last establishment or re-establishment, e.g., recovery, of the pod unit 111, and

a success condition of the last establishment or re-establishment, e.g., recovery, of the pod unit 111.

In some embodiments, the monitoring of the communication between the radio unit 110 and the at least one cloud processing node 131, 132, may trigger any suitable action, e.g., of the pod unit 111 and/or of the at least one cloud processing node 131, 132.

When the monitoring of the communication between the radio unit 110 and the at least one cloud processing node 131, 132, detects a condition and/or anomaly, the pod unit 111 may be signaled to perform any suitable action.

The monitoring of the communication between the radio unit 110 and the at least one cloud processing node 131, 132, may be used to monitor a state of the communication between the radio unit 110 and the at least one cloud processing node 131, 132, and which is signaled to the pod unit 111, e.g., such that the pod unit 111 may obtain a current version of the one or more state parameters. The monitoring of the communication between the radio unit 110 and the at least one cloud processing node 131, 132, may be performed periodically or in response to any suitable event.

To reduce the signalling overhead of the monitoring, the frequency may be set to be flexible, or based on a trained machine learning and/or artificial intelligence which is trained to perform the signalling relating to the monitoring at most suitable periods in time, e.g., based on an impact on the communication between the radio unit 110 and the at least one cloud processing node 131, 132, and/or to minimize requirements or resources used by the pod unit 111 for receiving the signalling.

### Action 506

The first cloud processing node 131 may, based on any one or more out of the monitored time, reason and/or success condition, adapt the communication between the radio unit 110 and the at least one cloud processing node 131, 132, e.g., by adjusting a number of cloud processing nodes in the at least one processing nodes 131, 132, and/or reallocating processing between nodes in the at least one processing nodes 131, 132.

### Action 507

Additionally or alternatively, the first cloud processing node 131 may be based on any one or more out of the monitored time, reason and/or success condition, trigger an alert, e.g., to indicate that there may be a problem with the communication between the radio unit 110 and the at least one cloud processing node 131, 132.

The alert may be a signal to any suitable network entity, e.g., the pod unit 111.

Embodiments herein such as the embodiments mentioned above will now be further described and exemplified. The text below is applicable to and may be combined with any suitable embodiment described above.

The Cloud RAN architecture has been developed by taking a legacy 5G architecture, and to gradually check potentials of taking some units and/or processing one by one to a Cloud environment. On a deployment side the development has started from the viewpoint of a non-standalone (NSA) NR architecture. This way of approaching to find a solution in Cloud RAN has reduced the chance of exploring full potentials of a Cloud Native design. Currently, a full stack virtualization of a 5G NR DU in Distributed RAN (DRAN) and a Centralized RAN (CRAN) configurations are deployed on COTS Hardware (HW).

If it is possible to design an architecture mainly to explore full potentials of a Cloud Native design, it is possible to move more parts of a telecommunications architecture, e.g., the 5G architecture, to a cloud environment and to keep a very small footprint at the base station, e.g., as in embodiments herein with the pod unit 111 and the radio unit 110.

With embodiments herein a near stateless pod, e.g., the pod unit 111, may be deployed at each radio site, and the at least one cloud processing node 131, 132 may perform the higher layer processing.

### Details on Stateless and Associated Cacheable State Parameters

When the term stateless is used herein, it may mean at least partly stateless and/or that at least some states, e.g., the one or more state parameters of actions above, are managed by the at least one cloud processing node 131, 132, e.g., instead of the pod unit 111, e.g., where a baseband processing unit typically are arranged to handle at least part of the one or more state parameters. The states, i.e. any one of the one or more state parameters, not being managed by the pod unit 111 and is instead managed by the at least one cloud processing node 131, 132 may relate to any one or more out of:

states relating to the UE 120, e.g., a UE context and/or UE identifiers,

states relating to RLC layer protocols,

states relating to higher layer protocols,

the states of the one or more state parameters as described above.

Managing the states as used herein may mean that the at least one cloud processing node 131, 132 stores the states and/or maintains the latest correct version of the states, e.g., such that the pod unit 111, when needed to re-establish, e.g., recover, the states, may obtain them from the at least one cloud processing node 131, 132 instead of having to have to store them to a non-volatile memory or storage locally within or associated with the pod unit 111.

With reference to the above and/or below, the pod unit 111 may be referred to as a stateless pod, or a semi-stateless pod.

In a conventional baseband processing setup, also referred to as a BB or BB pod, the states of cell/sector and UE configurations, e.g., the one or more state parameters, may be all kept within the storage of the corresponding, and in times of restart, this storage is then needed to be used for establishment or re-establishment, e.g., recovery. This approach may be slow and may put high requirements on a pod for storage space and storage reading/writing speeds. However, in embodiments herein, the UE and cell/sector states, e.g., the one or more state parameters, will be retrieved from the cloud, e.g., the at least one cloud processing node 131, 132, at the time of establishment or re-establishment, e.g., recovery, e.g., as in action 403. This means that the storage of the pod unit 111 is minimized/reduced to only cover inevitable stateful items that may be needed to be stored in the pod unit 111, e.g., as at least some states may be part of any device executing software.

In an example F1U deployment a BB pod implements the protocol stack for air interface in which some of those protocols are inherently stateful. Those protocols comprise:
Packet Data Convergence Protocol (PDCP) proxy, e.g., comprising stateful states for an F1U flow control,
RLC, e.g., comprising stateful states associated with an RLC window,
MAC, e.g., comprising stateful states for Hybrid Automatic Repeat request (HARQ) and/or for link adaptation,

By moving RLC to the Cloud, e.g., the at least one cloud processing node 131, 132, the most stateful BB protocol would be moved out from the BB pod, e.g., and not be part of the pod unit 111 as in embodiments herein. This would save memory in the pod unit 111 and to enable the pod unit 111 to restart very fast.

In the pod unit 111 of embodiments herein, a function to perform RLC segmentation may be needed to utilize a spectrum efficiently by segmenting and rebuilding headers for the RLC packets, e.g., as part of the one or more messages sent to the at least one cloud processing node 131, 132, e.g., for a best fit on a Transport Block (TB).

### Crash of the Pod Unit

In case of a crash of the pod unit 111:
the cells, e.g., of the radio unit 110, would be recovered or (re-) established very fast. This is since there may be no UE contexts that has to be maintained by the pod unit 111, and the DU-CP unit/processing will setup the cell/sectors, e.g., of the radio unit 110, such that the cells/sectors will be recovered or (re-) established before the UEs, e.g., the UE 120, trigger a Radio Link Failure (RLF),
For the UEs, e.g., the UE 120, in the MAC, a recovery list may need to be sent to reestablish endpoints, e.g., as part of action 403, to configure UE bearers and semi-statically allocated resources,
MAC states and HARQ buffers will be lost, but this is fast recovered or (re-) established by the embodiments herein, but may mean that a link adaptation may be sub-optimal,
HARQ buffers will be flushed meaning that RLC retransmission will be needed to cover HARQ that was ongoing when pod unit 111 went down, e.g., the RLC transmission may be triggered as part of the recovery or (re-) establishment as in action 403.

Since RLC is in the Cloud, e.g., the at least one cloud processing node 131, 132, the RLC states, e.g., as part of the one or more state parameters, may be maintained for the UEs, e.g., the UE 120, and data transfer can continue, even though the pod unit 111 has crashed.

Aside from making the pod unit 111 stateless, or at least nearly stateless, there is also a possibility with the Next Generation-Lower Layer Split (NG-LLS) to revive a configuration in the radio in the at least one cloud processing node 131, 132, and to make the radio part, e.g., the radio unit 110, stateless as well. The Layer 1 (L1) parts in the radio may be controlled from the pod unit 111 and are usually short term, so with the setup of having both the pod unit 111 stateless and/or nearly stateless, and the radio unit 110 stateless, there will be in scale of a 10th millisecond (ms) for the radio, e.g., of the radio unit 110, to recover or (re-) establish, e.g., when a crash occurs.

### Transportation Practices and Robustness

The pod unit 111 may not need to be a complete server, and can be comprised in any suitable device, e.g., as described above with reference to FIG. 2. Embodiments herein further allows for the whole RAN/Cloud RAN architecture to be changed, and all protocols may need to be revisited and/or re-evaluated due to a different setup of the processing performed in the at least one cloud processing node 131, 132, instead of in a local physical device.

The connection between the radio unit and the pod unit 111, e.g., as illustrated in FIG. 3, would take either the current NG-LLS i.e. the standardized version, or other LLS e.g., O-RAN LLS (OLLS). However, in this example it is represented as a generic “LLS”, which may be either one of these LLS items, a combination thereof, or a complete different one, as it may include new type of packaging of data in terms of configuration of radio/cell/sector and UE configurations, e.g., the one or more state parameters. In embodiments herein there may not be a DU and CU separation, e.g., as all processing can happen in the at least one cloud processing node 131, 132, and other units may also be completely virtualized, e.g., in the at least one cloud processing node 131, 132, and therefore the data sharing may have other characteristic to be considered than the one in the LLS, e.g., as there may be sharing possibilities between different entities in the same cloud node, or between cloud nodes of the at least one cloud processing node 131, 132.

In some embodiments, L1/L2 scheduling may be performed by the pod unit 111, e.g., wherein the pod unit 111 is integrated in the radio unit 110.

In some embodiments, for the protocols between the pod unit 111 and the at least one cloud processing node 131, 132, two new protocols CN-U-P and CN-C-P are defined for communication between the pod unit 111 and the at least one cloud processing node 131, 132. In some embodiments, these are just some proprietary setups which may for example in terms of user-plane use an original standardized protocol, i.e. F1-U. In some other embodiments, a commercially and/or open-source cross-platform data format such as protobuf by Google may be utilized.

The robustness and security of data transfer between the pod unit 111 and the at least one cloud processing node 131, 132 may fulfill all the current requirements of legacy communication in a Cloud RAN or RAN architecture.

### Latency and Delay Tolerance

When the data is processed closer to an actual UE, e.g., the UE 120, and the served radio unit, e.g., close to the edge, e.g., the radio unit 110, there is potential to have lower latency compared to when moving the data and decision process into the Cloud/core or SMO. Some embodiments may be a step away from Real-Time and near Real-Time domain, e.g., which may impact some communication use-cases unless proper latency considerations is in place for the transportation and/or data process units towards and within the at least one cloud processing node 131, 132.

As a result, some embodiments herein may not be suitable for some use-cases with ultra-low latency communication requirements. Instead, flexibility and efficiency in terms of processing and/or bandwidth may be achieved

Removing the distinction between DU and CU and also moving away from an F1 protocol, may in some embodiments remove delay in the wireless communications network 100 and communications therein.

### Time Synchronization

A critical difference in a Cloud RAN architecture, e.g., compared with legacy RAN architectures, is that synchronization is implemented differently. Purpose-built basebands may have built-in high-precision oscillators to provide very accurate synchronization to the radios, but COTS servers do not. Consequently, synchronization must be provided using Precision Timing Protocol (PTP) from a Primary Reference Riming Clock (PRTC). Hence, synchronization of embodiments herein may take a reference, e.g., as in PTP or PRTC, from any suitable device associated with the pod unit 111, e.g., an appliance 113, e.g., as in action 407.

Virtualization of Units into the Cloud

By moving many Cloud RAN units, such as DU-CP, CU-CP, CU-UP, etc. into the cloud, e.g., the at least one cloud processing node 131, 132, and making them completely virtual, it may be needed to define certain rules of their storage and/or process with respect to different and/or similar cloud environments. In some embodiments, due to security and/or robustness, it may be needed to have the units, e.g., the processing of these units, in a distributed fashion in different cloud setups, e.g., in different cloud processing nodes of the at least one cloud processing node 131, 132, while in some other embodiments, for having lower latency and/or faster responses it may be more suitable to use similar/same cloud domains and environments, e.g., to arrange the above units in the same cloud processing nodes of the at least one cloud processing node 131, 132, e.g., for improved sharing of resources.

### Cloud Implementation

Embodiments herein may utilize take most of a legacy Cloud RAN 5G architecture and move units, processing and/or the one or more state parameters to the at least one cloud processing node 131, 132, e.g., and make most of the current HW setup virtualized and/or to eliminate some of the current protocols such as F1. When moving the units and/or associated processing to the cloud, e.g., to the at least one cloud processing node 131, 132, there may no reason to have distinctions between DU and CU, and thus, their communication, synchronization, and/or division of processing is enabled to be optimized in any suitable manner.

### O-RAN Implementation

Embodiments herein may question the need of many O-RAN architecture parts. There may be a need to have a modified version of NG-LLS and/or OLLS setup between the radio unit 110 and the pod unit 111. To make a fronthaul, e.g., of the LLS stateless, there may be requirements to modify and have some changes in the current fronthaul protocols.

Some embodiments may define the CN-U-P and CN-C-P protocols.

A current architectural definition for a Near Real Time RAN Intelligent Controller (Near RT RIC), e.g., as part of the RAN wherein the pod unit 111 is comprised, may need to be revisited, as by moving everything, or many entities to the at least one cloud processing node 131, 132, this part may not exist any longer, e.g., and may be removed from the RAN, e.g., for a more lightweight communications system. This may also impact the A1 protocol as well, e.g., which may be possible to remove e.g., for a more lightweight communications system.

Embodiments herein may eliminate a need or use of F1 protocol e.g., for RAN and/or for a Cloud RAN architecture, e.g., which achieves a more lightweight communications system. F1 is a 3GPP protocol and a standardized interface for user plane and control plane data when using a Higher Layer Split (HLS) architecture. This can be a potential architectural 3GPP decision for 6G networks.

Embodiments herein may further comprise any one or more out of:
An RLC buffer split for Carrier Aggregation (CA), e.g., in the at least one cloud processing node 131, 132,
Internet Protocol (IP) transport for an E5 connection between appliances, e.g., the appliance 113, e.g., comprising the pod unit 111, and another appliance, e.g., for inter-appliance CA and/or spectrum sharing,
Connections from the appliance 113 to the radio unit 110 may be direct or may be switched, e.g., L2 or IP/L3,

To perform the method actions above, the pod unit 111 may be configured to handle communication between the radio unit 110 and the at least one cloud processing node 131, 132, in the wireless communications network 100. The pod unit 111 may be adapted to be part of the network node 112, e.g., a server or a base station, or part of the radio unit 110, or part of the appliance 113, e.g., a television box or smart device. The pod unit 111 is arranged to perform baseband processing for wireless signals sent to, and/or to be transmitted by, the radio unit (110). The baseband processing may be adapted to comprise layer 1 and/or Medium Access Control, MAC, processing. The at least one cloud processing node 131, 132, e.g., the first cloud processing node 131, is arranged to at least handle Radio Link Control, RLC, processing, of messages communicated between the pod unit 111 and the at least one cloud processing node 131, 132, e.g., the first cloud processing node 131.

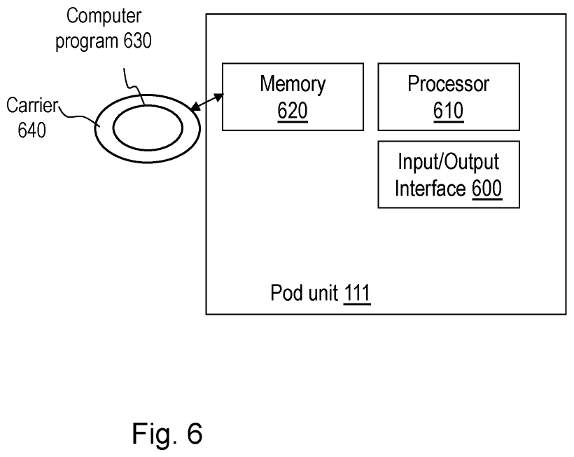

The pod unit 111 may comprise an arrangement depicted in FIG. 6. The pod unit 111 may comprise an input and output interface 600 configured to communicate in the wireless communications network 100, e.g., with any one or more out of the radio unit 110, the UE 120, and the at least one cloud processing node 131, 132. The input and output interface 600 may comprise a wireless receiver not shown, and a wireless transmitter not shown.

The pod unit 111 may further be configured to perform any one or more out of the actions 401-407 above, in any suitable order.

The pod unit 111 is configured to handle communication between the radio unit 110 and the at least one cloud processing node 131, 132 in the wireless communications network 100. The pod unit 111 is arranged to perform baseband processing for wireless signals sent to, and/or to be transmitted by, the radio unit 110. The at least one cloud processing node 131, 132 is arranged to at least handle RLC processing of messages communicated between the pod unit 111 and the at least one cloud processing node 131, 132.

The pod unit 111 is configured to perform baseband processing for wireless signals received by, and/or to be transmitted by, the radio unit 110.

The pod unit 111 is configured to: in conjunction with said performed baseband processing, communicate one or more messages, with the at least one cloud processing node 131, 132, wherein any one or both out of:
when received from the at least one cloud processing node 131, 132, the one or more messages are at least RLC processed by the at least one cloud processing node 131, 132, and
when transmitted to the at least one cloud processing node 131, 132, the one or more messages are at least RLC processed by the at least one cloud processing node 131, 132.

In some embodiments herein, the pod unit 111 is configured to:
obtain one or more state parameters indicative of at least one state associated with the communication between the radio unit 110 and the at least one cloud processing node 131, 132,
and wherein performing the baseband processing and/or communication of the one or more messages is/are based on the one or more state parameters.

In some embodiments herein, the pod unit 111 is configured to: cache the one or more state parameters, in a temporary storage of the pod unit 111.

In some embodiments herein, the pod unit 111 is configured to: when the one or more messages are transmitted to the at least one cloud processing node 131, 132, the one or more messages trigger the at least one cloud processing node 131, 132 to at least perform RLC processing of at least part of the one or more messages.

In some embodiments herein, the pod unit 111 is configured to: obtain the one or more state parameters by receiving the one or more state parameters from the at least one cloud processing node 131, 132. In some of these embodiments, the pod unit 111 is configured to receive the one or more state parameters in response to a restart of the pod unit 111. In some of these embodiments, the pod unit 111 is further configured to establish or re-establish, the communication between the radio unit 110 and the at least one cloud processing node 131, 132, based on the received one or more state parameters.

In some embodiments herein, the one or more state parameters are adapted to comprise or to be indicative of any one or more out of:
states, parameters, and/or configurations of a User Equipment, UE, 120, associated with the communication between the radio unit 110 and the at least one cloud processing node 131, 132,
states, parameters, and/or configurations of a cell associated with the communication between the radio unit 110 and the at least one cloud processing node 131, 132,
states, parameters, and/or configurations of a sector associated with the communication between the radio unit 110 and the at least one cloud processing node 131, 132,
one or more counters and/or constants associated with the communication between the radio unit 110 and the at least one cloud processing node 131, 132, and
one or more events associated with the communication between the radio unit 110 and the at least one cloud processing node 131, 132.

In some embodiments herein, the pod unit 111 is configured to monitor the communication between the radio unit 110 and the at least one cloud processing node 131, 132. In some of these embodiments, the pod unit 111 is configured to monitor the communication between the radio unit 110 and the at least one cloud processing node 131, 132, by obtaining one or more observations associated with the communication between the radio unit 110 and the at least one cloud processing node 131, 132. The one or more observations may be adapted to indicate a need for, and/or to trigger any one or more out of:
offloading processing from the pod unit 111 to the at least one cloud processing node 131, 132, and
alerting the radio unit 110 and/or a UE 120 of the radio unit 110.

In some embodiments herein, the pod unit 111 is configured to synchronize the radio unit 110, by synchronizing the radio unit 110 using an internal clock or oscillator associated with the pod unit 111.

To perform the method actions above, first cloud processing node 131 is configured to handle communication between the radio unit 110 and the at least one cloud processing node 131, 132, comprising the first cloud processing node 131 in the wireless communications network 100. The pod unit 111 is arranged to perform baseband processing for wireless signals sent to, and/or to be transmitted by, the radio unit 110. The baseband processing performed by the pod unit 111 may be adapted to comprise layer 1 and/or MAC processing. The pod unit 111 may be adapted to be part of a network node 112, e.g., a server or a base station, or adapted to be part of the radio unit 110, or the appliance 113. The first cloud processing node 131 is arranged to at least handle RLC processing, of messages communicated between the pod unit 111 and the at least one cloud processing node 131, 132, e.g., the first cloud processing node 131.

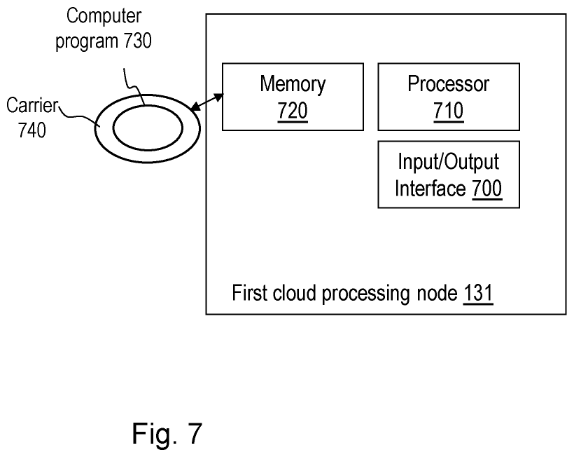

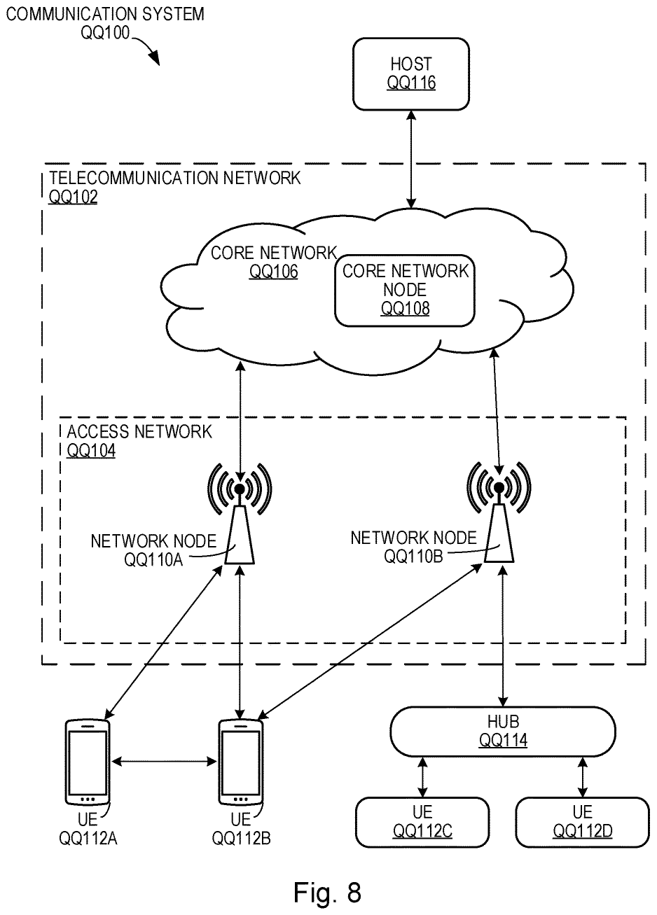

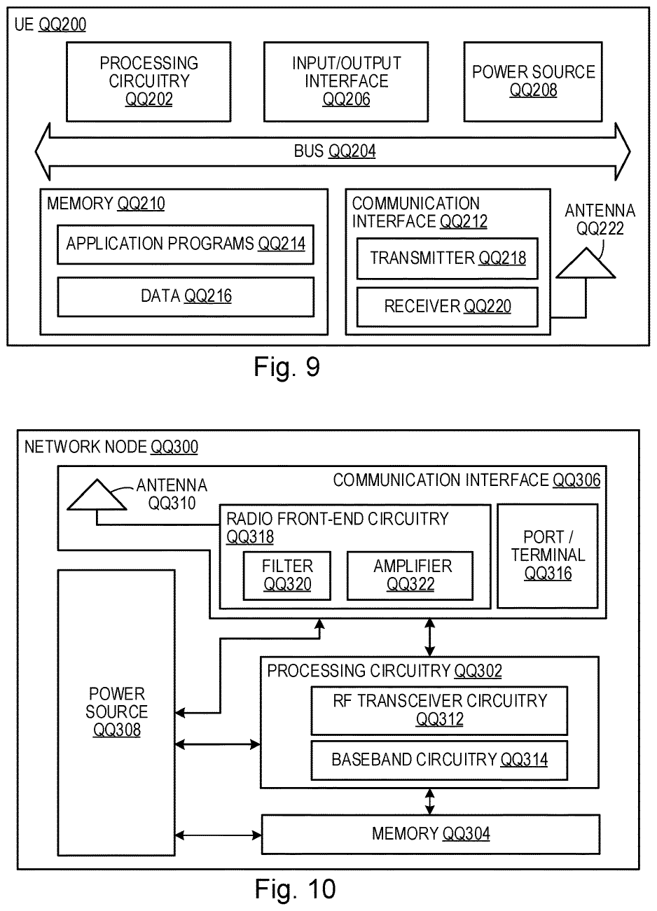

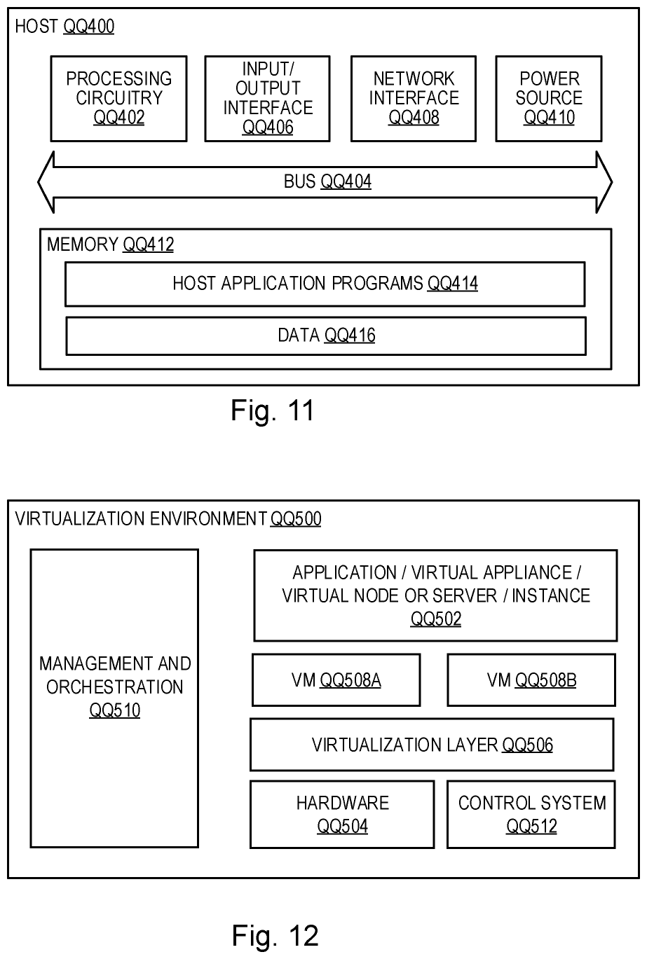

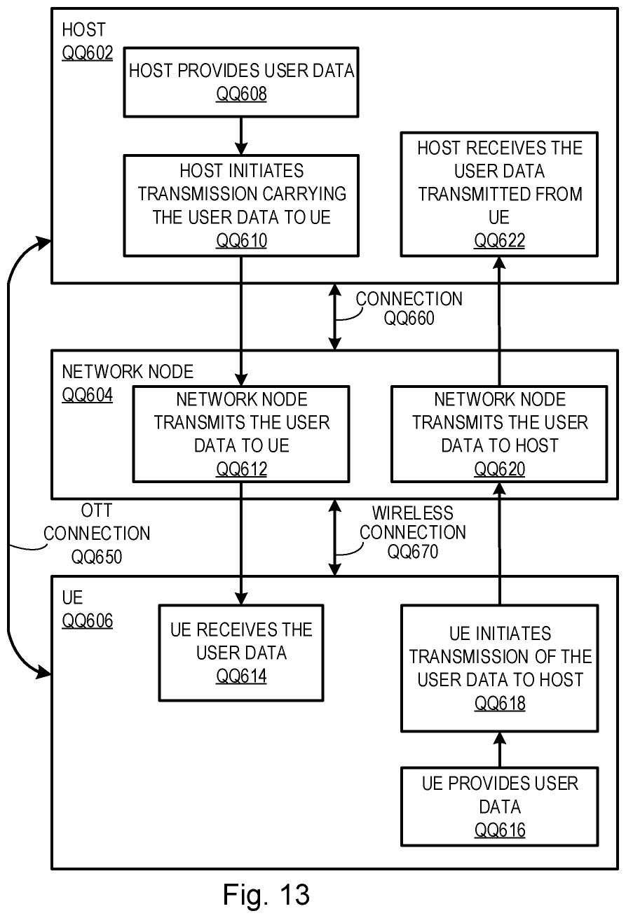

The first cloud processing node 131 may comprise an arrangement depicted in FIG. 7. The first cloud processing node 131 may comprise an input and output interface 700 configured to communicate in the wireless communications network 100, e.g., with any one or more out of the radio unit 110, the pod unit 111, the UE 120, and the at least one cloud processing node 131, 132. The input and output interface 700 may comprise a wireless receiver not shown, and a wireless transmitter not shown.

The first cloud processing node 131 may further be configured to perform any one or more out of the actions 501-507 above, in any suitable order.

The first cloud processing node 131 is configured to handle communication between the radio unit 110 and the at least one cloud processing node 131, 132 comprising the first cloud processing node 131 in the wireless communications network 100. The pod unit 111 is arranged to perform baseband processing for wireless signals sent to, and/or to be transmitted by, the radio unit 110. The first cloud processing node 131 is arranged to at least handle RLC processing, of messages communicated between the pod unit 111 and the at least one cloud processing node 131, 132 comprising the first cloud processing node 131.

The first cloud processing node 131 is configured to perform at least RLC processing of at least part of one or more messages transmitted to and/or received from the pod unit 111. The first cloud processing node 131 is configured to, in conjunction with performing at least RLC processing of at least part of the one or more messages, communicate said one or more messages, with the pod unit 111. The one or more messages are adapted to:
when transmitted to the pod unit 111, the one or more messages are arranged to be transmitted to be baseband processed by the pod unit 111, and/or
when received from the pod unit 111, the one or more messages are baseband processed by the pod unit 111, and wherein the one or more messages are arranged to trigger the first cloud processing node 131 to perform the RLC processing of at least part of the one or more messages.

In some embodiments, the first cloud processing node 131 is configured to obtain and/or maintain one or more state parameters indicative of at least one state associated with the communication between the radio unit 110 and the at least one cloud processing node 131, 132. In some embodiments, the first cloud processing node 131 is configured to perform the at least RLC processing of the at least part of the one or more messages and/or communicating the one or more messages based on the one or more state parameters.

In some embodiments, the one or more state parameters are stored and/or maintained in a non-volatile memory or storage associated with the at least one cloud processing node 131, 132.

In some embodiments, the first cloud processing node 131 is configured to transmit the one or more state parameters to the pod unit 111.

In some embodiments, the one or more state parameters are transmitted in response to a restart and/or crash of the pod unit 111.

In some embodiments, the first cloud processing node 131 is configured to perform the at least RLC processing of at least part of the one or more messages by any one or more out of:
handling an RLC window of the communication between the radio unit 110 and the at least one cloud processing node 131, 132,
handling RLC buffer insertion associated with the communication between the radio unit 110 and the at least one cloud processing node 131, 132,
handing processing relating to any one or more out of:
   i. Control Plane, CP, processing,
   ii. User Plane, UP, processing,
   iii. Container as a Service, CaaS, controller processing.

In these embodiments, the processing may be adapted to be associated with the communication between the radio unit 110 and the at least one cloud processing node 131, 132.

In some embodiments, the first cloud processing node 131 is configured to monitor the communication between the radio unit 110 and the at least one cloud processing node 131, 132, by monitoring
a time since a last establishment or re-establishment of the pod unit 111,
a reason of the last establishment or re-establishment of the pod unit 111, and
a success condition of the last establishment or re-establishment of the pod unit 111.

In some embodiments, the first cloud processing node 131 is configured to, based on any one or more out of the monitored time, reason and/or success condition adapt the communication between the radio unit 110 and the at least one cloud processing node 131, 132.

In some embodiments, the first cloud processing node 131 is configured to: based on any one or more out of the monitored time, reason and/or success condition, trigger an alert.

In some embodiments, the one or more state parameters are adapted to comprise or to be indicative of any one or more out of:
states, parameters, and/or configurations of a User Equipment, UE, 120, associated with the communication between the radio unit 110 and the at least one cloud processing node 131, 132,
states, parameters, and/or configurations of a cell associated with the communication between the radio unit 110 and the at least one cloud processing node 131, 132,
states, parameters, and/or configurations of a sector associated with the communication between the radio unit 110 and the at least one cloud processing node 131, 132,
one or more counters and/or constants associated with the communication between the radio unit 110 and the at least one cloud processing node 131, 132,
one or more events associated with the communication between the radio unit 110 and the at least one cloud processing node 131, 132.

The embodiments herein may be implemented through a respective processor or one or more processors, such as the respective processor 610 of a processing circuitry in the pod unit 111 depicted in FIG. 6, and processor 710 of a processing circuitry in the first cloud processing node 131 depicted in FIG. 7 together with respective computer program code for performing the functions and actions of the embodiments herein. The program codes mentioned above may respectively also be provided as a respective computer program product, for instance in the form of a respective data carrier carrying computer program code for performing the respective embodiments herein when being loaded into the respective pod unit 111 and the first cloud processing node 131. One such carrier may be in the form of a CD ROM disc. It is however feasible with other data carriers such as a memory stick. The computer program code may respectively furthermore be provided as pure program code on a server and downloaded to the pod unit 111 and/or the first cloud processing node 131.

The pod unit 111 and first cloud processing node 131 may further comprise a respective memory 720 and memory 620 comprising one or more memory units. The respective memory 720 and memory 620 comprises instructions executable by the respective processor in the respective pod unit 111 and first cloud processing node 131. The respective memory 720 and memory 620 are arranged to be used to store e.g., parameters, states, information, indications, data, configurations, communication data, and applications to perform the methods herein when being executed in the respective pod unit 111 and first cloud processing node 131.

In some embodiments, a respective computer program 730 and computer program 630 comprises instructions, which when executed by the respective at least one processor 710 and processor 610, cause the at least one processor of respective first pod unit 111 and first cloud processing node 131 to perform the actions above.

In some embodiments, a respective carrier 740 and carrier 640 comprises the respective computer program 730 and computer program 630, wherein the respective carrier 740 and carrier 640 is one of an electronic signal, an optical signal, an electromagnetic signal, a magnetic signal, an electric signal, a radio signal, a microwave signal, or a computer-readable storage medium.

The pod unit 111 may further be a virtual instance of a software executed, e.g., as a Kubernetes pod, e.g., by the processor 610, as part of the radio unit 110, the network node 112, the appliance 113, or in any other suitable network entity or control unit in the wireless communications network 100.

Those skilled in the art will appreciate that units in the respective pod unit 111 and first cloud processing node 131 described above may refer to a combination of analog and digital circuits, and/or one or more processors configured with software and/or firmware, e.g. stored in the respective pod unit 111 and first cloud processing node 131, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

### Embodiments

Below, some example Embodiments 1-23 are shortly described. See e.g. FIGS. 1, 2, 3, 4, 5, 6, and 7. The Embodiments 1-23 may be combined with any of the other embodiments herein in any suitable manner.

Embodiment 1. A method performed by a pod unit 111, e.g., for handling communication between a radio unit 110 and at least one cloud processing node 131, 132, in a wireless communications network 100, e.g., wherein the pod unit 111 is part of a network node 112, e.g., a server, base station, or a radio unit 110, or an appliance 113, e.g., wherein the pod unit 111 is arranged to perform baseband processing for wireless signals sent to, and/or to be transmitted by, the radio unit 110, e.g., wherein the baseband processing comprises layer 1 and/or Medium Access Control, MAC, processing, and wherein the at least one cloud processing node 131, 132 is arranged to at least handle Radio Link Control, RLC, processing, of messages communicated between the pod unit 111 and the at least one cloud processing node 131, 132, the method comprising any one or more out of:

obtaining 401 e.g., receiving from the at least one cloud processing node 131, 132, one or more state parameters indicative of at least one state associated with the communication between the radio unit 110 and the at least one cloud processing node 131, 132, and optionally caching 402 the one or more state parameters, in a temporary storage of the pod unit 111, e.g., wherein the one or more state parameters are lost when the pod unit 111 is restarted,

performing 404 baseband processing for wireless signals received by, and/or to be transmitted by, the radio unit 110, e.g., layer 1 and/or MAC processing, e.g., based on the one or more state parameters,

in conjunction with said performed 404 baseband processing, communicating 405 one or more messages, to and/or from the at least one cloud processing node 131, 132, e.g., based on the one or more state parameters, wherein said one or more messages is:
when received from the at least one cloud processing node 131, 132, the one or more messages are at least RLC processed by the at least one cloud processing node 131, 132, and/or
when transmitted to the at least one cloud processing node 131, 132, the one or more messages are transmitted to be at least RLC processed by the at least one cloud processing node 131, 132, e.g., wherein the one or more messages trigger the at least one cloud processing node 131, 132 to at least perform RLC processing of at least part of the one or more messages.

Embodiment 2. The method according to Embodiment 1, wherein obtaining 401 the one or more state parameters comprises receiving the one or more state parameters from the at least one cloud processing node 131, 132, and is performed in response to a restart of the pod unit 111, e.g., due to a crash of the pod unit 111, and wherein the method further comprises establishing or re-establishing 403, e.g., recovering, the communication between the radio unit 110 and the at least one cloud processing node 131, 132, e.g., based on the received one or more state parameters.

Embodiment 3. The method according to any of Embodiments 1-2, wherein the one or more state parameters comprises or is indicative of any one or more out of:
states, parameters, and/or configurations of a User Equipment, UE, 120, associated with the communication between the radio unit 110 and the at least one cloud processing node 131, 132, e.g., a UE context of the UE 120,
states, parameters, and/or configurations of a cell associated with the communication between the radio unit 110 and the at least one cloud processing node 131, 132, e.g., such as a frequency band of the cell, Cell Identifier such as a Physical Cell Identifier, PCI, a type of the cell, identifiers of neighbour cells and/or numbers of neighbour cells,
states, parameters, and/or configurations of a sector associated with the communication between the radio unit 110 and the at least one cloud processing node 131, 132, e.g., a beam configuration, a beam ID, one or more antenna configurations, indication of reference signals in uplink and/or downlink,

one or more counters and/or constants associated with the communication between the radio unit 110 and the at least one cloud processing node 131, 132, e.g., Radio Resource Control, RRC, counters and/or constants defining a target number of attempts for one or more events in the communication between the radio unit 110 and the at least one cloud processing node 131, 132,

one or more events associated with the communication between the radio unit 110 and the at least one cloud processing node 131, 132, e.g., handover events, security control events, periodic and/or triggered measurements of the communication between the radio unit 110 and the at least one cloud processing node 131, 132.

Embodiment 4. The method according to any of Embodiments 1-3, wherein the method further comprises monitoring 406 the communication between the radio unit 110 and the at least one cloud processing node 131, 132, e.g., based on the one or more state parameters, e.g., wherein monitoring 406 the communication between the radio unit 110 and the at least one cloud processing node 131, 132, comprises obtaining one or more observations associated with the communication between the radio unit 110 and the at least one cloud processing node 131, 132, e.g., any one or more out of assistance data, acknowledgements, and/or measurements, e.g., wherein the one or more observations indicates a need for, and/or triggers any one or more out of:
offloading processing from the pod unit 111 to the at least one cloud processing node 131, 132,
alerting the radio unit 110 and/or a UE 120 of the radio unit 110.

Embodiment 5. The method according to any of Embodiments 1-4, wherein the method further comprises synchronizing 407 the radio unit 110, wherein synchronizing 407 the radio unit 110 comprises using an internal clock or oscillator associated with the pod unit 111.

Embodiment 6. A method performed by a first cloud processing node 131, e.g., for handling communication between a radio unit 110 and at least one cloud processing node 131, 132 comprising the first cloud processing node 131, in a wireless communications network 100, e.g., wherein a pod unit 111 is arranged to perform baseband processing for wireless signals sent to, and/or to be transmitted by, the radio unit 110, e.g., wherein the baseband processing comprises layer 1 and/or Medium Access Control, MAC, processing, e.g., and wherein the pod unit 111 is part of a network node 112, e.g., a server, base station, or a radio unit 110, or an appliance 113, and wherein the first cloud processing node 131 is arranged to at least handle Radio Link Control, RLC, processing, of messages communicated between the pod unit 111 and the at least one cloud processing node 131, 132, the method comprising any one or more out of:

obtaining and/or maintaining 501 one or more state parameters indicative of at least one state associated with the communication between the radio unit 110 and the at least one cloud processing node 131, 132, e.g., wherein the one or more state parameters are stored and/or maintained in a non-volatile memory or storage associated with the at least one cloud processing node 131, 132,

transmitting 502 the one or more state parameters to the pod unit 111, e.g., for being temporarily cached and/or used by the pod unit 111, e.g., in response to a restart and/or crash of the pod unit 111,

performing 503 at least RLC processing of at least part of one or more messages, e.g., based on the one or more state parameters,

in conjunction with performing 503 at least RLC processing of at least part of one or more messages, e.g., based on the one or more state parameters, communicating 504 said one or more messages, with the pod unit 111, e.g., based on the one or more state parameters,

e.g., wherein said one or more messages are:
when the one or more messages are transmitted to the pod unit 111, the one or more messages are transmitted to be baseband processed by the pod unit 111, and/or
when the one or more messages are received from the pod unit 111, the one or more messages are baseband processed by the pod unit 111, triggering first cloud processing node 131 to perform 503 the RLC processing of at least part of the one or more messages.

Embodiment 7. The method according to Embodiment 6, wherein performing 503 the at least RLC processing of at least part of the one or more messages comprises any one or more out of:
handling an RLC window of the communication between the radio unit 110 and the at least one cloud processing node 131, 132,
handling RLC buffer insertion associated with the communication between the radio unit 110 and the at least one cloud processing node 131, 132,
handing processing relating to any one or more out of:

Control Plane, CP, processing, e.g., Distributed Unit, DU, -CP processing and/or Centralized Unit, CU, -CP processing,

User Plane, UP, processing e.g., CU-UP processing,

Container as a Service, CaaS, controller processing,

wherein the processing is associated with the communication between the radio unit 110 and the at least one cloud processing node 131, 132, e.g., in coordination with a second cloud processing node 132 of the at least one cloud processing node 131, 132.

Embodiment 8. The method according to any of Embodiments 6-7, wherein the method further comprises monitoring 505 the communication between the radio unit 110 and the at least one cloud processing node 131, 132, e.g., based on the one or more state parameters, e.g., wherein monitoring 505 the communication between the radio unit 110 and the at least one cloud processing node 131, 132, comprises monitoring
a time since a last establishment or re-establishment, e.g., recovery, of the pod unit 111, e.g., a time since transmitting 502 the one or more state parameters to the pod unit 111,
a reason of the last establishment or re-establishment, e.g., recovery, of the pod unit 111,
a success condition of the last establishment or re-establishment, e.g., recovery, of the pod unit 111.

Embodiment 9. The method according to Embodiment 8, wherein, based on any one or more out of the monitored time, reason and/or success condition, adapting 506 the communication between the radio unit 110 and the at least one cloud processing node 131, 132, and/or triggering 507 an alert.

Embodiment 10. The method according to any of Embodiments 6-9, wherein the one or more state parameters comprises or is indicative of any one or more out of:
states, parameters, and/or configurations of a User Equipment, UE, 120, associated with the communication between the radio unit 110 and the at least one cloud processing node 131, 132, e.g., a UE context of the UE 120,
states, parameters, and/or configurations of a cell associated with the communication between the radio unit 110 and the at least one cloud processing node 131, 132, e.g., such as a frequency band of the cell, Cell Identifier such as a Physical Cell Identifier, PCI, a type of the cell, identifiers of neighbour cells and/or numbers of neighbour cells,
states, parameters, and/or configurations of a sector associated with the communication between the radio unit 110 and the at least one cloud processing node 131, 132, e.g., a beam configuration, a beam ID, one or more antenna configurations, indication of reference signals in uplink and/or downlink,

one or more counters and/or constants associated with the communication between the radio unit 110 and the at least one cloud processing node 131, 132, e.g., Radio Resource Control, RRC, counters and/or constants defining a target number of attempts for one or more events in the communication between the radio unit 110 and the at least one cloud processing node 131, 132,

one or more events associated with the communication between the radio unit 110 and the at least one cloud processing node 131, 132, e.g., handover events, security control events, periodic and/or triggered measurements of the communication between the radio unit 110 and the at least one cloud processing node 131, 132.

Embodiment 11. A pod unit 111, e.g., configured to handle communication between a radio unit 110 and at least one cloud processing node 131, 132, in a wireless communications network 100, e.g., wherein the pod unit 111 is adapted to be part of a network node 112, e.g., a server, base station, or a radio unit 110, or an appliance 113, e.g., wherein the pod unit 111 is arranged to perform baseband processing for wireless signals sent to, and/or to be transmitted by, the radio unit 110, e.g., wherein the baseband processing is adapted to comprise layer 1 and/or Medium Access Control, MAC, processing, and wherein the at least one cloud processing node 131, 132 is arranged to at least handle Radio Link Control, RLC, processing, of messages communicated between the pod unit 111 and the at least one cloud processing node 131, 132, the pod unit 111 being configured to any one or more out of:

obtain, e.g., receive from the at least one cloud processing node 131, 132, one or more state parameters indicative of at least one state associated with the communication between the radio unit 110 and the at least one cloud processing node 131, 132,

cache the one or more state parameters, in a temporary storage of the pod unit 111, e.g., wherein the one or more state parameters are arranged to be lost when the pod unit 111 is restarted,

perform baseband processing for wireless signals received by, and/or to be transmitted by, the radio unit 110, e.g., layer 1 and/or MAC processing, e.g., based on the one or more state parameters,

in conjunction with said performed baseband processing, communicate one or more messages, with the at least one cloud processing node 131, 132, e.g., based on the one or more state parameters, wherein said one or more messages are adapted to be:
when received from the at least one cloud processing node 131, 132, the one or more messages are at least RLC processed by the at least one cloud processing node 131, 132, and/or
when transmitted to the at least one cloud processing node 131, 132, the one or more messages are at least RLC processed by the at least one cloud processing node 131, 132, e.g., wherein the one or more messages are adapted to trigger the at least one cloud processing node 131, 132 to at least perform RLC processing of at least part of the one or more messages.

Embodiment 12. The pod unit 111 according to Embodiment 11, further configured to obtain the one or more state parameters by receiving the one or more state parameters from the at least one cloud processing node 131, 132, and wherein the pod unit 111 is configured to receive the one or more state parameters in response to a restart of the pod unit 111, e.g., due to a crash of the pod unit 111, and wherein the pod unit 111 is further configured to establish or re-establish, e.g., recover, the communication between the radio unit 110 and the at least one cloud processing node 131, 132, e.g., based on the received one or more state parameters.

Embodiment 13. The pod unit 111 according to any of Embodiments 11-12, wherein the one or more state parameters are adapted to comprise or to be indicative of any one or more out of:
states, parameters, and/or configurations of a User Equipment, UE, 120, associated with the communication between the radio unit 110 and the at least one cloud processing node 131, 132, e.g., a UE context of the UE 120,
states, parameters, and/or configurations of a cell associated with the communication between the radio unit 110 and the at least one cloud processing node 131, 132, e.g., such as a frequency band of the cell, Cell Identifier such as a Physical Cell Identifier, PCI, a type of the cell, identifiers of neighbour cells and/or numbers of neighbour cells,
states, parameters, and/or configurations of a sector associated with the communication between the radio unit 110 and the at least one cloud processing node 131, 132, e.g., a beam configuration, a beam ID, one or more antenna configurations, indication of reference signals in uplink and/or downlink,

one or more counters and/or constants associated with the communication between the radio unit 110 and the at least one cloud processing node 131, 132, e.g., Radio Resource Control, RRC, counters and/or constants defining a target number of attempts for one or more events in the communication between the radio unit 110 and the at least one cloud processing node 131, 132,

one or more events associated with the communication between the radio unit 110 and the at least one cloud processing node 131, 132, e.g., handover events, security control events, periodic and/or triggered measurements of the communication between the radio unit 110 and the at least one cloud processing node 131, 132.

Embodiment 14. The pod unit 111 according to any of Embodiments 11-13, wherein the pod unit 111 is further configured to monitor the communication between the radio unit 110 and the at least one cloud processing node 131, 132, e.g., based on the one or more state parameters, e.g., wherein the pod unit 111 is configured to monitor the communication between the radio unit 110 and the at least one cloud processing node 131, 132, by obtaining one or more observations associated with the communication between the radio unit 110 and the at least one cloud processing node 131, 132, e.g., any one or more out of assistance data, acknowledgements, and/or measurements, e.g., wherein the one or more observations are adapted to indicate a need for, and/or to trigger any one or more out of:
offloading processing from the pod unit 111 to the at least one cloud processing node 131, 132,
alerting the radio unit 110 and/or a UE 120 of the radio unit 110.

Embodiment 15. The pod unit 111 according to any of Embodiments 11-14, wherein the pod unit 111 further is configured to synchronize the radio unit 110, by synchronizing the radio unit 110 using an internal clock or oscillator associated with the pod unit 111.

Embodiment 16. A first cloud processing node 131, e.g., configured to handle communication between a radio unit 110 and at least one cloud processing node 131, 132 comprising the first cloud processing node 131, in a wireless communications network 100, e.g., wherein a pod unit 111 is arranged to perform baseband processing for wireless signals sent to, and/or to be transmitted by, the radio unit 110, e.g., wherein the baseband processing is adapted to comprise layer 1 and/or Medium Access Control, MAC, processing, e.g., and wherein the pod unit 111 is adapted to be part of a network node 112, e.g., a server, base station, or a radio unit 110, or an appliance 113, and wherein the first cloud processing node 131 is arranged to at least handle Radio Link Control, RLC, processing, of messages communicated between the pod unit 111 and the at least one cloud processing node 131, 132 comprising the first cloud processing node 131, the first cloud processing node 131 being configured to any one or more out of:

obtain and/or maintain one or more state parameters indicative of at least one state associated with the communication between the radio unit 110 and the at least one cloud processing node 131, 132, e.g., wherein the one or more state parameters are adapted to be stored and/or maintained in a non-volatile memory or storage associated with the at least one cloud processing node 131, 132,

transmit the one or more state parameters to the pod unit 111, e.g., for being temporarily cached and/or used by the pod unit 111, e.g., in response to a restart and/or crash of the pod unit 111,

perform at least RLC processing of at least part of one or more messages, e.g., based on the one or more state parameters,

in conjunction with performing at least RLC processing of at least part of one or more messages, e.g., based on the one or more state parameters, communicate said one or more messages, with the pod unit 111, e.g., based on the one or more state parameters,

e.g., wherein said one or more messages are adapted to:
when transmitted to the pod unit 111, the one or more messages are arranged to be transmitted to be baseband processed by the pod unit 111, and/or
when received from the pod unit 111, the one or more messages are baseband processed by the pod unit 111, and wherein the one or more messages are arranged to trigger the first cloud processing node 131 to perform the RLC processing of at least part of the one or more messages.

Embodiment 17. The first cloud processing node 131 according to Embodiment 16, configured to perform the at least RLC processing of at least part of the one or more messages by any one or more out of:
handling an RLC window of the communication between the radio unit 110 and the at least one cloud processing node 131, 132,
handling RLC buffer insertion associated with the communication between the radio unit 110 and the at least one cloud processing node 131, 132,
handing processing relating to any one or more out of:
   Control Plane, CP, processing, e.g., Distributed Unit, DU, -CP processing and/or Centralized Unit, CU, -CP processing,
   User Plane, UP, processing e.g., CU-UP processing,
   Container as a Service, CaaS, controller processing,

wherein the processing is adapted to be associated with the communication between the radio unit 110 and the at least one cloud processing node 131, 132, e.g., in coordination with a second cloud processing node 132 of the at least one cloud processing node 131, 132.

Embodiment 18. The first cloud processing node 131 according to any of Embodiments 16-17, wherein the first cloud processing node 131 is further configured to monitor the communication between the radio unit 110 and the at least one cloud processing node 131, 132, e.g., based on the one or more state parameters, e.g., by monitoring
a time since a last establishment or re-establishment, e.g., recovery, of the pod unit 111, e.g., a time since transmitting the one or more state parameters to the pod unit 111,
a reason of the last establishment or re-establishment, e.g., recovery, of the pod unit 111, and
a success condition of the last establishment or re-establishment, e.g., recovery, of the pod unit 111.

Embodiment 19. The first cloud processing node 131 according to Embodiment 18, further configured to: based on any one or more out of the monitored time, reason and/or success condition,

adapt the communication between the radio unit 110 and the at least one cloud processing node 131, 132, and/or

trigger an alert.

Embodiment 20. The first cloud processing node 131 according to any of Embodiments 16-19, wherein the one or more state parameters are adapted to comprise or to be indicative of any one or more out of:
states, parameters, and/or configurations of a User Equipment, UE, 120, associated with the communication between the radio unit 110 and the at least one cloud processing node 131, 132, e.g., a UE context of the UE 120,
states, parameters, and/or configurations of a cell associated with the communication between the radio unit 110 and the at least one cloud processing node 131, 132, e.g., such as a frequency band of the cell, Cell Identifier such as a Physical Cell Identifier, PCI, a type of the cell, identifiers of neighbour cells and/or numbers of neighbour cells,
states, parameters, and/or configurations of a sector associated with the communication between the radio unit 110 and the at least one cloud processing node 131, 132, e.g., a beam configuration, a beam ID, one or more antenna configurations, indication of reference signals in uplink and/or downlink,

one or more counters and/or constants associated with the communication between the radio unit 110 and the at least one cloud processing node 131, 132, e.g., Radio Resource Control, RRC, counters and/or constants defining a target number of attempts for one or more events in the communication between the radio unit 110 and the at least one cloud processing node 131, 132,

one or more events associated with the communication between the radio unit 110 and the at least one cloud processing node 131, 132, e.g., handover events, security control events, periodic and/or triggered measurements of the communication between the radio unit 110 and the at least one cloud processing node 131, 132.

Embodiment 21. A computer program 630 comprising instructions, which when executed by a processor 610, causes the processor to perform actions according to any of the Embodiments 1-5.

Embodiment 22. A carrier 640 comprising the computer program 630 of Embodiment 21, wherein the carrier is one of an electronic signal, an optical signal, an electromagnetic signal, a magnetic signal, an electric signal, a radio signal, a microwave signal, or a computer-readable storage medium.

Embodiment 22. A computer program 730 comprising instructions, which when executed by a processor 710, causes the processor to perform actions according to any of the Embodiments 6-10.

Embodiment 23. A carrier 740 comprising the computer program 730 of Embodiment 22, wherein the carrier is one of an electronic signal, an optical signal, an electromagnetic signal, a magnetic signal, an electric signal, a radio signal, a microwave signal, or a computer-readable storage medium.

### Additional Explanation

Some of the embodiments contemplated herein will now be described more fully with reference to the accompanying drawings. Embodiments are provided by way of example to convey the scope of the subject matter to those skilled in the art.

FIG. 1 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMAX), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 4 is a block diagram of a host QQ400, which may be an embodiment of the host QQ116 of FIG. 1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors

(VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508. The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 1 and/or UE QQ200 of FIG. 2), network node (such as network node QQ110a of FIG. 1 and/or network node QQ300 of FIG. 3), and host (such as host QQ116 of FIG. 1 and/or host QQ400 of FIG. 4) discussed in the preceding paragraphs will now be described with reference to FIG. 6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the flexibility, efficiency and/or power consumption and thereby provide benefits such as e.g., reduced user wait time, more flexible setup, extended battery lifetime, improved content resolution, and/or improved scalability.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

The below table may define any abbreviation used above or in embodiments herein.

| Abbreviation | Explanation |
|---|---|
| vDU | virtualized Distributed Unit |
| vCU | virtualized Centralized Unit |
| Cloud RAN | Cloud Radio Access Network |
| SMO | Service Management and Orchestration |
| HW | Hardware |
| SW | Software |
| CU-UP | Centralized Unit - User Plane |
| CU-CP | Centralized Unit - Control Plane |
| BB | Baseband |
| COTS | Commercial off the Shelf |
| HLS | Higher Layer Split |
| PDCP | Packet Data Convergence Protocol |
| MAC | Media Access Control |
| RLC | Radio Link Control |
| Near RT RIC | Near Real Time RAN Intelligent Controller |
| CN-C-P | Cloud Native Control Protocol |
| CN-U-P | Cloud Native User Protocol |
| TB | Transport Block |
| NG-LLS | Next Generation - Lower Layer Split |
| oLLS | O-RAN (open) - Lower Layer Split |

1-40. (canceled)

41. A method performed by a pod unit for handling communication between a radio unit and at least one cloud processing node in a wireless communications network, the method comprising:
performing baseband processing for wireless signals received by, and/or to be transmitted by, the radio unit; and
communicating, in conjunction with the performed baseband processing, one or more messages with the at least one cloud processing node;
wherein the at least one cloud processing node is configured to at least handle Radio Link Control (RLC) processing of messages communicated between the pod unit and the at least one cloud processing node; and
wherein any one or both out of:
when received from the at least one cloud processing node, the one or more messages are at least RLC processed by the at least one cloud processing node; and
when transmitted to the at least one cloud processing node, the one or more messages are transmitted to be at least RLC processed by the at least one cloud processing node.

42. The method of claim 41, further comprising:
obtaining one or more state parameters indicative of at least one state associated with the communication between the radio unit and the at least one cloud processing node;
wherein performing the baseband processing and/or communicating the one or more messages are based on the one or more state parameters.

43. The method of claim 42, further comprising caching the one or more state parameters, in a temporary storage of the pod unit.

44. The method of claim 42, wherein:
obtaining the one or more state parameters comprises receiving the one or more state parameters from the at least one cloud processing node and is performed in response to a restart of the pod unit; and
the method further comprises establishing or re-establishing the communication between the radio unit and the at least one cloud processing node based on the received one or more state parameters.

45. The method of claim 42, wherein the one or more state parameters comprises or is indicative of any one or more out of:
states, parameters, and/or configurations of a User Equipment (UE) associated with the communication between the radio unit and the at least one cloud processing node;
states, parameters, and/or configurations of a cell associated with the communication between the radio unit and the at least one cloud processing node;
states, parameters, and/or configurations of a sector associated with the communication between the radio unit and the at least one cloud processing node;
one or more counters and/or constants associated with the communication between the radio unit and the at least one cloud processing node; and
one or more events associated with the communication between the radio unit and the at least one cloud processing node.

46. The method of claim 41, further comprising monitoring the communication between the radio unit and the at least one cloud processing node, wherein:
monitoring the communication between the radio unit and the at least one cloud processing node comprises obtaining one or more observations associated with the communication between the radio unit and the at least one cloud processing node; and
the one or more observations indicates a need for, and/or triggers any one or more out of:
offloading processing from the pod unit to the at least one cloud processing node; and
alerting the radio unit and/or a UE of the radio unit.

47. A method performed by a first cloud processing node for handling communication between a radio unit and at least one cloud processing node comprising the first cloud processing node in a wireless communications network, the method comprising:
performing at least Radio Link Control (RLC) processing of at least part of one or more messages transmitted to and/or received from a pod unit configured to perform baseband processing for wireless signals sent to, and/or to be transmitted by, the radio unit; and
communicating, in conjunction with performing at least RLC processing of at least part of the one or more messages, said one or more messages with the pod unit;
wherein the first cloud processing node is configured to at least handle RLC processing of messages communicated between the pod unit and the at least one cloud processing node; and
wherein any one or both out of:
when the one or more messages are transmitted to the pod unit, the one or more messages are transmitted to be baseband processed by the pod unit; or
when the one or more messages are received from the pod unit, the one or more messages are baseband processed by the pod unit, triggering first cloud processing node to perform the RLC processing of at least part of the one or more messages.

48. The method of claim 47, further comprising:
obtaining and/or maintaining one or more state parameters indicative of at least one state associated with the communication between the radio unit and the at least one cloud processing node;
wherein performing the at least RLC processing of the at least part of the one or more messages and/or communicating the one or more messages are based on the one or more state parameters.

49. The method of claim 48, wherein the one or more state parameters are stored and/or maintained in a non-volatile memory or storage associated with the at least one cloud processing node.

50. A pod unit configured to handle communication between a radio unit and at least one cloud processing node in a wireless communications network, wherein the pod unit comprises:
processing circuitry and interface circuitry communicatively connected to the processing circuitry, wherein the processing circuitry is configured to:
perform baseband processing for wireless signals received by, and/or to be transmitted by, the radio unit; and
communicate, in conjunction with said performed baseband processing, one or more messages with the at least one cloud processing node via the interface circuitry;
wherein the at least one cloud processing node is configured to at least handle Radio Link Control (RLC) processing of messages communicated between the pod unit and the at least one cloud processing node; and
wherein any one or both out of:
when received from the at least one cloud processing node, the one or more messages are at least RLC processed by the at least one cloud processing node; or
when transmitted to the at least one cloud processing node, the one or more messages are at least RLC processed by the at least one cloud processing node.

51. The pod unit of claim 50, wherein:
the processing circuitry is further configured to obtain one or more state parameters indicative of at least one state associated with the communication between the radio unit and the at least one cloud processing node;
performing the baseband processing and/or communication of the one or more messages is/are based on the one or more state parameters.

52. A first cloud processing node for handling communication between a radio unit and at least one cloud processing node comprising the first cloud processing node in a wireless communications network, the first cloud processing node comprising:
processing circuitry and interface circuitry communicatively connected to the processing circuitry, wherein the processing circuitry is configured to:
perform at least Radio Link Control (RLC) processing of at least part of one or more messages transmitted to and/or received from a pod unit configured to perform baseband processing for wireless signals sent to, and/or to be transmitted by, the radio unit; and
communicate, in conjunction with performing at least RLC processing of at least part of the one or more messages, said one or more messages with the pod unit via the interface circuitry;
wherein the first cloud processing node is configured to at least handle RLC processing of messages communicated between the pod unit and the at least one cloud processing node; and
wherein any one or both out of:
when the one or more messages are transmitted to the pod unit, the one or more messages are transmitted to be baseband processed by the pod unit; or
when the one or more messages are received from the pod unit, the one or more messages are baseband processed by the pod unit, triggering first cloud processing node to perform the RLC processing of at least part of the one or more messages.

53. The first cloud processing node of claim 52, wherein:
the processing circuitry is further configured to obtain and/or maintain one or more state parameters indicative of at least one state associated with the communication between the radio unit and the at least one cloud processing node; and
performing the at least RLC processing of the at least part of the one or more messages and/or communicating the one or more messages is/are based on the one or more state parameters.

54. A non-transitory computer readable medium storing software instructions that, when run on processing circuitry of a pod unit for handling communication between a radio unit and at least one cloud processing node in a communications network, cause the pod unit to:
perform baseband processing for wireless signals received by, and/or to be transmitted by, the radio unit; and
communicate, in conjunction with said performed baseband processing, one or more messages with the at least one cloud processing node;
wherein the at least one cloud processing node is configured to at least handle Radio Link Control (RLC) processing of messages communicated between the pod unit and the at least one cloud processing node;
wherein any one or both out of:
when received from the at least one cloud processing node, the one or more messages are at least RLC processed by the at least one cloud processing node; or
when transmitted to the at least one cloud processing node, the one or more messages are transmitted to be at least RLC processed by the at least one cloud processing node.

55. A non-transitory computer readable medium storing software instructions that, when run on processing circuitry of a first cloud processing node for handling communication between a radio unit and at least one cloud processing node in a communications network, cause the first cloud processing node to:
perform at least Radio Link Control (RLC) processing of at least part of one or more messages transmitted to and/or received from a pod unit configured to perform baseband processing for wireless signals sent to, and/or to be transmitted by, the radio unit; and
communicate, in conjunction with performing at least RLC processing of at least part of the one or more messages, said one or more messages with the pod unit;
wherein the first cloud processing node is configured to at least handle RLC processing of messages communicated between the pod unit and the at least one cloud processing node; and
wherein any one or both out of:
when the one or more messages are transmitted to the pod unit, the one or more messages are transmitted to be baseband processed by the pod unit; or
when the one or more messages are received from the pod unit, the one or more messages are baseband processed by the pod unit, triggering first cloud processing node to perform the RLC processing of at least part of the one or more messages.
